(19) United States
(12) Patent Application Publication
(10) Pub. No.: US 2023/0305125 A1
(43) Pub. Date: Sep. 28, 2023

(54) METHODS AND SYSTEMS FOR DETECTION OF GALVANOMETER MIRROR ZERO POSITION ANGLE OFFSET AND FAULT DETECTION IN LIDAR

(71) Applicant: Innovusion, Inc., Sunnyvale, CA (US)

(72) Inventors: Haosen Wang, Sunnyvale, CA (US); Yimin Li, Cupertino, CA (US)

(73) Assignee: Innovusion, Inc., Sunnyvale, CA (US)

(21) Appl. No.: 18/126,059

(22) Filed: Mar. 24, 2023

Related U.S. Application Data
(60) Provisional application No. 63/324,009, filed on Mar. 25, 2022.

(51) Int. Cl. G01S 7/497; G01S 17/931; G01S 17/89

(52) U.S. Cl. CPC G01S 7/497; G01S 17/931; G01S 17/89

(57) ABSTRACT

A fault-detection system for detecting fault in a LiDAR system mounted on a vehicle is provided. The LiDAR system is configured to provide point cloud data of an external environment of the vehicle in accordance with a LiDAR coordinate system. The fault-detection system includes processor-executable instructions which comprise instructions for: obtaining a vehicle speed; obtaining conversion parameters used for converting from the LiDAR coordinate system to a vehicle coordinate system; determining whether the vehicle speed exceeds a vehicle speed threshold; in accordance with a determination that the vehicle speed exceeds the vehicle speed threshold, obtaining a representation of a road surface plane expressed in the vehicle coordinate system; obtaining a representation of a native horizontal plane provided by the vehicle; and determining whether a fault in the LiDAR system has occurred based on the representation of the road surface plane and the representation of the native horizontal plane.

### CROSS-REFERENCE TO RELATED APPLICATIONS

This application claims priority to U.S. Provisional Patent Application Ser. No. 63/324,009, filed Mar. 25, 2022, entitled “Methods And Systems For Detection Of Galvanometer Mirror Zero Position Angle Offset And Fault Detection In LiDAR,” the content of which is hereby incorporated by reference in its entirety for all purposes.

### FIELD OF THE TECHNOLOGY

This disclosure relates generally to optical scanning and, more particularly, to detection of galvanometer mirror zero position angle offset and fault detection in a LiDAR system.

### BACKGROUND

Light detection and ranging (LiDAR) systems use light pulses to create an image or point cloud of the external environment. A LiDAR system may be a scanning or non-scanning system. Some typical scanning LiDAR systems include a light source, a light transmitter, a light steering system, and a light detector. The light source generates a light beam that is directed by the light steering system in particular directions when being transmitted from the LiDAR system. When a transmitted light beam is scattered or reflected by an object, a portion of the scattered or reflected light returns to the LiDAR system to form a return light pulse. The light detector detects the return light pulse. Using the difference between the time that the return light pulse is detected and the time that a corresponding light pulse in the light beam is transmitted, the LiDAR system can determine the distance to the object based on the speed of light. This technique of determining the distance is referred to as the time-of-flight (ToF) technique. The light steering system can direct light beams along different paths to allow the LiDAR system to scan the surrounding environment and produce images or point clouds. A typical non-scanning LiDAR system illuminate an entire field-of-view (FOV) rather than scanning through the FOV. An example of the non-scanning LiDAR system is a flash LiDAR, which can also use the ToF technique to measure the distance to an object. LiDAR systems can also use techniques other than time-of-flight and scanning to measure the surrounding environment.

### SUMMARY

Some LiDAR systems use a galvanometer mirror to scan in one direction, e.g., the vertical direction, of the FOV. The galvanometer mirror oscillates about an axis between two end positions. A center position is located at the midpoint of the two end positions. The angular position at the midpoint is referred to as the zero position of the galvanometer mirror. By oscillating between the two end positions, the galvanometer mirror scans the outgoing light to cover a vertical range of the FOV.

Since the LiDAR system is mounted on or integrated to a vehicle, factors such as vibrations of the vehicle may cause a shift in the zero position of the galvanometer mirror over time. This shift can result in a corresponding shift in the LiDAR view of the surrounding environment. Consequently, the vertical position of objects in the LiDAR view may be inaccurately measured. This can lead to errors in the further processing of the LiDAR data. Any inaccuracies in the LiDAR data may pose a risk to the safety of passengers onboard. Therefore, it is important to timely detect any changes in the zero position of the galvanometer mirror and the resulting fault in the LiDAR system.

One way to detect the fault in the galvanometer mirror is to examine the position of the galvanometer mirror during regular vehicle maintenance, and recalibrate the system by readjusting the position of the mirror to the correct position. However, it may take a long time between two maintenance checks. Any faults that occur in the meantime may go undetected and pose a potential safety risk to the passengers onboard. In this disclosure, a fault-detection system that can detect faults in the galvanometer minor and the LiDAR system in real-time is disclosed.

In one embodiment, a fault-detection system for detecting fault in a LiDAR system mounted on a vehicle is provided. The LiDAR system is configured to provide point cloud data of an external environment of the vehicle in accordance with a LiDAR coordinate system. The fault-detection system includes one or more processors, a memory device, and processor-executable instructions stored in the memory device. The processor-executable instructions comprise instructions for: obtaining a vehicle speed; obtaining conversion parameters used for converting from the LiDAR coordinate system to a vehicle coordinate system; determining whether the vehicle speed exceeds a vehicle speed threshold; in accordance with a determination that the vehicle speed exceeds the vehicle speed threshold, obtaining a representation of a road surface plane expressed in the vehicle coordinate system; obtaining a representation of a native horizontal plane provided by the vehicle; and determining whether a fault in the LiDAR system has occurred based on the representation of the road surface plane and the representation of the native horizontal plane.

In another embodiment, a method for detecting fault in a LiDAR system mounted on a vehicle is provided. The method comprises obtaining a vehicle speed; obtaining conversion parameters used for converting from the LiDAR coordinate system to a vehicle coordinate system; determining whether the vehicle speed exceeds a vehicle speed threshold; in accordance with a determination that the vehicle speed exceeds the vehicle speed threshold, obtaining a representation of a road surface plane expressed in the vehicle coordinate system; obtaining a representation of a native horizontal plane provided by the vehicle; and determining whether a fault in the LiDAR system has occurred based on the representation of the road surface plane and the representation of the native horizontal plane.

### BRIEF DESCRIPTION OF THE DRAWINGS

The present application can be best understood by reference to the embodiments described below taken in conjunction with the accompanying drawing figures, in which like parts may be referred to by like numerals.

FIG. 1 illustrates one or more example LiDAR systems disposed or included in a motor vehicle.

FIG. 2 is a block diagram illustrating interactions between an example LiDAR system and multiple other systems including a vehicle perception and planning system.

FIG. 3 is a block diagram illustrating an example LiDAR system.

FIG. 4 is a block diagram illustrating an example fiber-based laser source.

FIGS. 5A-5C illustrate an example LiDAR system using pulse signals to measure distances to objects disposed in a field-of-view (FOV).

FIG. 6 is a block diagram illustrating an example apparatus used to implement systems, apparatus, and methods in various embodiments.

FIG. 7 is a block diagram illustrating an exemplary arrangement of components in a steering mechanism of a LiDAR system according to one embodiment.

FIG. 8A illustrates a LiDAR view of a road scene when the zero angle position of the galvanometer mirror in the LiDAR system is not shifted.

FIG. 8B illustrates a LiDAR view of a road scene when the zero angle position of the galvanometer mirror in the LiDAR system has been shifted.

FIG. 9A illustrates a road scene from a lateral perspective when the zero angle position of the galvanometer mirror in the LiDAR system is not shifted.

FIG. 9B illustrates a road scene from a lateral perspective when the zero angle position of the galvanometer mirror in the LiDAR system has been shifted.

FIG. 10 illustrates a camera view of a road scene taken by a camera mounted on the vehicle's front bumper.

FIG. 11 depicts a 3D plot graph that shows a correlation between the LiDAR coordinate system and the vehicle coordinate system according to one embodiment.

FIG. 12 depicts a 3D plot graph that shows a correlation between the road surface plane and the vehicle's native horizontal plane according to one embodiment.

FIG. 13 is a flowchart illustrating a method for detecting fault in a LiDAR system mounted on a vehicle.

### DETAILED DESCRIPTION

To provide a more thorough understanding of various embodiments of the present invention, the following description sets forth numerous specific details, such as specific configurations, parameters, examples, and the like. It should be recognized, however, that such description is not intended as a limitation on the scope of the present invention but is intended to provide a better description of the exemplary embodiments.

Throughout the specification and claims, the following terms take the meanings explicitly associated herein, unless the context clearly dictates otherwise:

The phrase “in one embodiment” as used herein does not necessarily refer to the same embodiment, though it may. Thus, as described below, various embodiments of the disclosure may be readily combined, without departing from the scope or spirit of the invention.

As used herein, the term “or” is an inclusive “or” operator and is equivalent to the term “and/or,” unless the context clearly dictates otherwise.

The term “based on” is not exclusive and allows for being based on additional factors not described unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of a networked environment where two or more components or devices are able to exchange data, the terms “coupled to” and “coupled with” are also used to mean “communicatively coupled with”, possibly via one or more intermediary devices. The components or devices can be optical, mechanical, and/or electrical devices.

Although the following description uses terms “first,” “second,” etc. to describe various elements, these elements should not be limited by the terms. These terms are only used to distinguish one element from another. For example, a first sensor could be termed a second sensor and, similarly, a second sensor could be termed a first sensor, without departing from the scope of the various described examples. The first sensor and the second sensor can both be sensors and, in some cases, can be separate and different sensors.

In addition, throughout the specification, the meaning of “a”, “an”, and “the” includes plural references, and the meaning of “in” includes “in” and “on”.

Although some of the various embodiments presented herein constitute a single combination of inventive elements, it should be appreciated that the inventive subject matter is considered to include all possible combinations of the disclosed elements. As such, if one embodiment comprises elements A, B, and C, and another embodiment comprises elements B and D, then the inventive subject matter is also considered to include other remaining combinations of A, B, C, or D, even if not explicitly discussed herein. Further, the transitional term “comprising” means to have as parts or members, or to be those parts or members, As used herein, the transitional term “comprising” is inclusive or open-ended and does not exclude additional, unrecited elements or method steps.

As used in the description herein and throughout the claims that follow, when a system, engine, server, device, module, or other computing element is described as being configured to perform or execute functions on data in a memory, the meaning of “configured to” or “programmed to” is defined as one or more processors or cores of the computing element being programmed by a set of software instructions stored in the memory of the computing element to execute the set of functions on target data or data objects stored in the memory.

It should be noted that any language directed to a computer should be read to include any suitable combination of computing devices or network platforms, including servers, interfaces, systems, databases, agents, peers, engines, controllers, modules, or other types of computing devices operating individually or collectively. One should appreciate the computing devices comprise a processor configured to execute software instructions stored on a tangible, non-transitory computer readable storage medium (e.g., hard drive, FPGA, PLA, solid state drive, RAM, flash, ROM, or any other volatile or non-volatile storage devices). The software instructions configure or program the computing device to provide the roles, responsibilities, or other functionality as discussed below with respect to the disclosed apparatus. Further, the disclosed technologies can be embodied as a computer program product that includes a non-transitory computer readable medium storing the software instructions that causes a processor to execute the disclosed steps associated with implementations of computer-based algorithms, processes, methods, or other instructions. In some embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges among devices can be conducted over a packet-switched network, the Internet, LAN, WAN, VPN, or other type of packet switched network; a circuit switched network; cell switched network; or other type of network.

Embodiments of present invention are described below. In various embodiments of the present invention, a fault-detection system for detecting fault in a LiDAR system mounted on a vehicle is provided. The LiDAR system is configured to provide point cloud data of an external environment of the vehicle in accordance with a LiDAR coordinate system. The fault-detection system includes one or more processors, a memory device, and processor-executable instructions stored in the memory device. The processor-executable instructions comprise instructions for: obtaining a vehicle speed; obtaining conversion parameters used for converting from the LiDAR coordinate system to a vehicle coordinate system; determining whether the vehicle speed exceeds a vehicle speed threshold; in accordance with a determination that the vehicle speed exceeds the vehicle speed threshold, obtaining a representation of a road surface plane expressed in the vehicle coordinate system; obtaining a representation of a native horizontal plane provided by the vehicle; and determining whether a fault in the LiDAR system has occurred based on the representation of the road surface plane and the representation of the native horizontal plane.

An advantage of the present invention is that the fault-detection system can detect faults in galvanometer mirror in real-time. This ability allows for prompt identification and detection of faults in both the galvanometer mirror and LiDAR system. Since faults in the galvanometer mirror may pose potential safety risks to passengers, the system's ability to detect such faults in real-time is important for ensuring passenger safety.

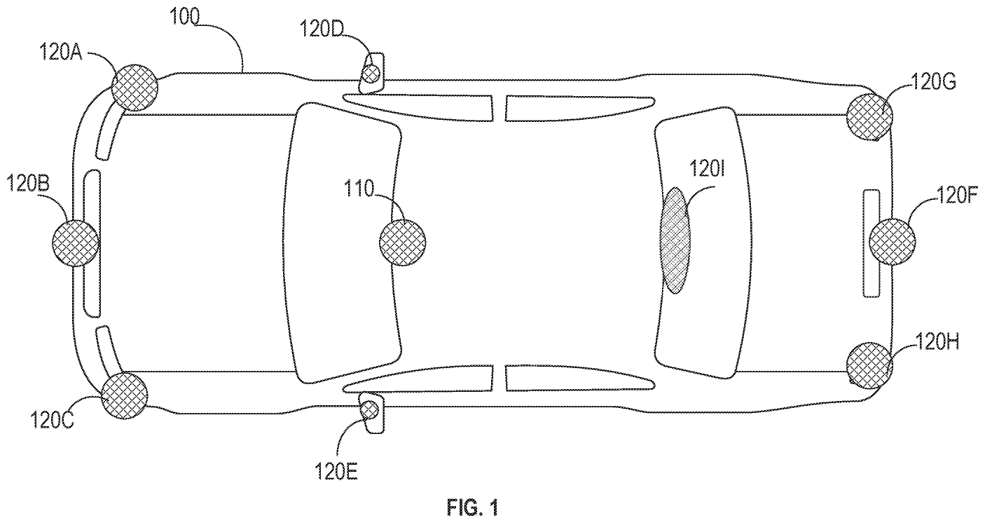

FIG. 1 illustrates one or more example LiDAR systems 110 disposed or included in a motor vehicle 100. Vehicle 100 can be a car, a sport utility vehicle (SUV), a truck, a train, a wagon, a bicycle, a motorcycle, a tricycle, a bus, a mobility scooter, a tram, a ship, a boat, an underwater vehicle, an airplane, a helicopter, a unmanned aviation vehicle (UAV), a spacecraft, etc. Motor vehicle 100 can be a vehicle having any automated level. For example, motor vehicle 100 can be a partially automated vehicle, a highly automated vehicle, a fully automated vehicle, or a driverless vehicle. A partially automated vehicle can perform some driving functions without a human driver's intervention. For example, a partially automated vehicle can perform blind-spot monitoring, lane keeping and/or lane changing operations, automated emergency braking, smart cruising and/or traffic following, or the like. Certain operations of a partially automated vehicle may be limited to specific applications or driving scenarios (e.g., limited to only freeway driving). A highly automated vehicle can generally perform all operations of a partially automated vehicle but with less limitations. A highly automated vehicle can also detect its own limits in operating the vehicle and ask the driver to take over the control of the vehicle when necessary. A fully automated vehicle can perform all vehicle operations without a driver's intervention but can also detect its own limits and ask the driver to take over when necessary. A driverless vehicle can operate on its own without any driver intervention.

In typical configurations, motor vehicle 100 comprises one or more LiDAR systems 110 and 120A-120I. Each of LiDAR systems 110 and 120A-120I can be a scanning-based LiDAR system and/or a non-scanning LiDAR system (e.g., a flash LiDAR). A scanning-based LiDAR system scans one or more light beams in one or more directions (e.g., horizontal and vertical directions) to detect objects in a field-of-view (FOV). A non-scanning based LiDAR system transmits laser light to illuminate an FOV without scanning. For example, a flash LiDAR is a type of non-scanning based LiDAR system. A flash LiDAR can transmit laser light to simultaneously illuminate an FOV using a single light pulse or light shot.

A LiDAR system is a frequently-used sensor of a vehicle that is at least partially automated. In one embodiment, as shown in FIG. 1, motor vehicle 100 may include a single LiDAR system 110 (e.g., without LiDAR systems 120A-120I) disposed at the highest position of the vehicle (e.g., at the vehicle roof). Disposing LiDAR system 110 at the vehicle roof facilitates a 360-degree scanning around vehicle 100. In some other embodiments, motor vehicle 100 can include multiple LiDAR systems, including two or more of systems 110 and/or 120A-120I. As shown in FIG. 1, in one embodiment, multiple LiDAR systems 110 and/or 120A-120I are attached to vehicle 100 at different locations of the vehicle. For example, LiDAR system 120A is attached to vehicle 100 at the front right corner; LiDAR system 1208 is attached to vehicle 100 at the front center position; LiDAR system 120C is attached to vehicle 100 at the front left corner; LiDAR system 120D is attached to vehicle 100 at the right-side rear view mirror; LiDAR system 120E is attached to vehicle 100 at the left-side rear view mirror; LiDAR system 120F is attached to vehicle 100 at the back center position; LiDAR system 120G is attached to vehicle 100 at the back right corner; LiDAR system 120H is attached to vehicle 100 at the back left corner; and/or LiDAR system 120I is attached to vehicle 100 at the center towards the backend (e.g., back end of the vehicle roof). It is understood that one or more LiDAR systems can be distributed and attached to a vehicle in any desired manner and FIG. 1 only illustrates one embodiment. As another example, LiDAR systems 120D and 120E may be attached to the B-pillars of vehicle 100 instead of the rear-view mirrors. As another example, LiDAR system 120B may be attached to the windshield of vehicle 100 instead of the front bumper.

In some embodiments, LiDAR systems 110 and 120A-120I are independent LiDAR systems having their own respective laser sources, control electronics, transmitters, receivers, and/or steering mechanisms. In other embodiments, some of LiDAR systems 110 and 120A-120I can share one or more components, thereby forming a distributed sensor system. In one example, optical fibers are used to deliver laser light from a centralized laser source to all LiDAR systems. For instance, system 110 (or another system that is centrally positioned or positioned anywhere inside the vehicle 100) includes a light source, a transmitter, and a light detector, but have no steering mechanisms. System 110 may distribute transmission light to each of systems 120A-120I. The transmission light may be distributed via optical fibers. Optical connectors can be used to couple the optical fibers to each of system 110 and 120A-120I. In some examples, one or more of systems 120A-120I include steering mechanisms but no light sources, transmitters, or light detectors. A steering mechanism may include one or more moveable mirrors such as one or more polygon mirrors, one or more single plane mirrors, one or more multi-plane mirrors, or the like. Embodiments of the light source, transmitter, steering mechanism, and light detector are described in more detail below. Via the steeling mechanisms, one or more of systems 120A-120I scan light into one or more respective FOVs and receive corresponding return light. The return light is formed by scattering or reflecting the transmission light by one or more objects in the FOVs. Systems 120A-120I may also include collection lens and/or other optics to focus and/or direct the return light into optical fibers, which deliver the received return light to system 110. System 110 includes one or more light detectors for detecting the received return light. In some examples, system 110 is disposed inside a vehicle such that it is in a temperature-controlled environment, while one or more systems 120A-120I may be at least partially exposed to the external environment.

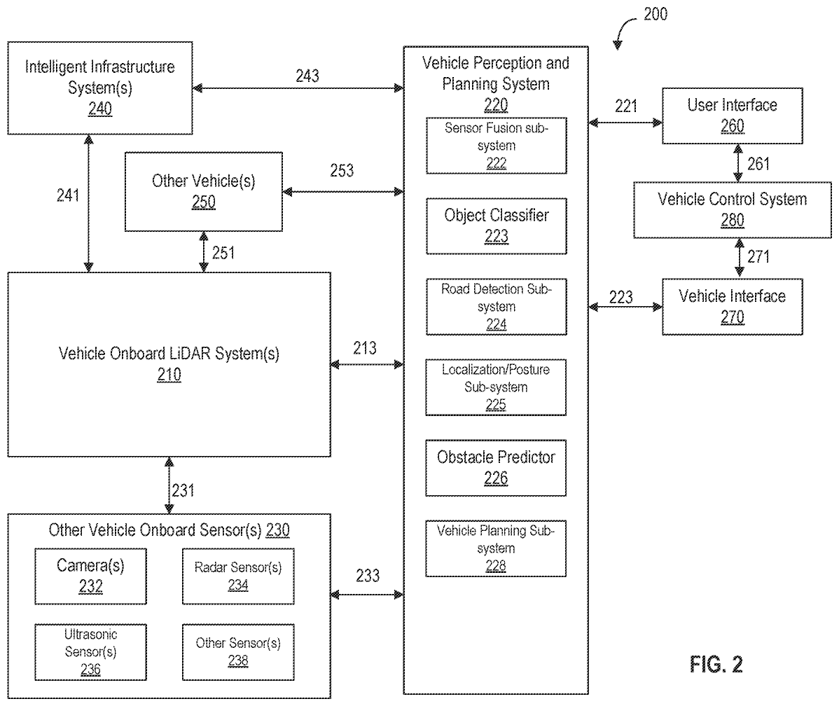

FIG. 2 is a block diagram 200 illustrating interactions between vehicle onboard LiDAR system(s) 210 and multiple other systems including a vehicle perception and planning system 220. LiDAR system(s) 210 can be mounted on or integrated to a vehicle. LiDAR system(s) 210 include sensor(s) that scan laser light to the surrounding environment to measure the distance, angle, and/or velocity of objects. Based on the scattered light that returned to LiDAR system(s) 210, it can generate sensor data (e.g., image data or 3D point cloud data) representing the perceived external environment.

LiDAR system(s) 210 can include one or more of short-range LiDAR sensors, medium-range LiDAR sensors, and long-range LiDAR sensors. A short-range LiDAR sensor measures objects located up to about 20-50 meters from the LiDAR sensor. Short-range LiDAR sensors can be used for, e.g., monitoring nearby moving objects (e.g., pedestrians crossing street in a school zone), parking assistance applications, or the like. A medium-range LiDAR sensor measures objects located up to about 70-200 meters from the LiDAR sensor. Medium-range LiDAR sensors can be used for, e.g., monitoring road intersections, assistance for merging onto or leaving a freeway, or the like. A long-range LiDAR sensor measures objects located up to about 200 meters and beyond. Long-range LiDAR sensors are typically used when a vehicle is travelling at a high speed (e.g., on a freeway), such that the vehicle's control systems may only have a few seconds (e.g., 6-8 seconds) to respond to any situations detected by the LiDAR sensor. As shown in FIG. 2, in one embodiment, the LiDAR sensor data can be provided to vehicle perception and planning system 220 via a communication path 213 for further processing and controlling the vehicle operations. Communication path 213 can be any wired or wireless communication links that can transfer data.

With reference still to FIG. 2, in some embodiments, other vehicle onboard sensor(s) 230 are configured to provide additional sensor data separately or together with LiDAR system(s) 210. Other vehicle onboard sensors 230 may include, for example, one or more camera(s) 232, one or more radar(s) 234, one or more ultrasonic sensor(s) 236, and/or other sensor(s) 238. Camera(s) 232 can take images and/or videos of the external environment of a vehicle. Camera(s) 232 can take, for example, high-definition (HD) videos having millions of pixels in each frame. A camera includes image sensors that facilitates producing monochrome or color images and videos. Color information may be important in interpreting data for some situations (e.g., interpreting images of traffic lights). Color information may not be available from other sensors such as LiDAR or radar sensors. Camera(s) 232 can include one or more of narrow-focus cameras, wider-focus cameras, side-facing cameras, infrared cameras, fisheye cameras, or the like. The image and/or video data generated by camera(s) 232 can also be provided to vehicle perception and planning system 220 via communication path 233 for further processing and controlling the vehicle operations. Communication path 233 can be any wired or wireless communication links that can transfer data. Camera(s) 232 can be mount on, or integrated to, a vehicle at any locations (e.g., rear-view mirrors, pillars, front grille, and/or back bumpers, etc.).

Other vehicle onboard sensor(s) 230 can also include radar sensor(s) 234. Radar sensor(s) 234 use radio waves to determine the range, angle, and velocity of objects. Radar sensor(s) 234 produce electromagnetic waves in the radio or microwave spectrum. The electromagnetic waves reflect off an object and some of the reflected waves return to the radar sensor, thereby providing information about the object's position and velocity. Radar sensor(s) 234 can include one or more of short-range radar(s), medium-range radar(s), and long-range radar(s). A short-range radar measures objects located at about 0.1-30 meters from the radar. A short-range radar is useful in detecting objects located nearby the vehicle, such as other vehicles, buildings, walls, pedestrians, bicyclists, etc. A short-range radar can be used to detect a blind spot, assist in lane changing, provide rear-end collision warning, assist in parking, provide emergency braking, or the like. A medium-range radar measures objects located at about 30-80 meters from the radar. A long-range radar measures objects located at about 80-200 meters. Medium- and/or long-range radars can be useful in, for example, traffic following, adaptive cruise control, and/or highway automatic braking. Sensor data generated by radar sensor(s) 234 can also be provided to vehicle perception and planning system 220 via communication path 233 for further processing and controlling the vehicle operations. Radar sensor(s) 234 can be mount on, or integrated to, a vehicle at any locations (e.g., rear-view mirrors, pillars, front grille, and/or back bumpers, etc.).

Other vehicle onboard sensor(s) 230 can also include ultrasonic sensor(s) 236. Ultrasonic sensor(s) 236 use acoustic waves or pulses to measure object located external to a vehicle. The acoustic waves generated by ultrasonic sensor(s) 236 are transmitted to the surrounding environment. At least some of the transmitted waves are reflected off an object and return to the ultrasonic sensor(s) 236. Based on the return signals, a distance of the object can be calculated. Ultrasonic sensor(s) 236 can be useful in, for example, checking blind spots, identifying parking spaces, providing lane changing assistance into traffic, or the like. Sensor data generated by ultrasonic sensor(s) 236 can also be provided to vehicle perception and planning system 220 via communication path 233 for further processing and controlling the vehicle operations. Ultrasonic sensor(s) 236 can be mount on, or integrated to, a vehicle at any locations (e.g., rear-view mirrors, pillars, front grille, and/or back bumpers, etc.).

In some embodiments, one or more other sensor(s) 238 may be attached in a vehicle and may also generate sensor data. Other sensor(s) 238 may include, for example, global positioning systems (GPS), inertial measurement units (IMU), or the like. Sensor data generated by other sensor(s) 238 can also be provided to vehicle perception and planning system 220 via communication path 233 for further processing and controlling the vehicle operations. It is understood that communication path 233 may include one or more communication links to transfer data between the various sensor(s) 230 and vehicle perception and planning system 220,

In some embodiments, as shown in FIG. 2, sensor data from other vehicle onboard sensor(s) 230 can be provided to vehicle onboard LiDAR system(s) 210 via communication path 231. LiDAR system(s) 210 may process the sensor data from other vehicle onboard sensor(s) 230. For example, sensor data from camera(s) 232, radar sensor(s) 234, ultrasonic sensor(s) 236, and/or other sensor(s) 238 may be correlated or fused with sensor data LiDAR system(s) 210, thereby at least partially offloading the sensor fusion process performed by vehicle perception and planning system 220. It is understood that other configurations may also be implemented for transmitting and processing sensor data from the various sensors (e.g., data can be transmitted to a cloud or edge computing service provider for processing and then the processing results can be transmitted back to the vehicle perception and planning system 220 and/or LiDAR system 210).

With reference still to FIG. 2, in some embodiments, sensors onboard other vehicle(s) 250 are used to provide additional sensor data separately or together with LiDAR system(s) 210. For example, two or more nearby vehicles may have their own respective LiDAR sensor(s), camera(s), radar sensor(s), ultrasonic sensor(s), etc. Nearby vehicles can communicate and share sensor data with one another. Communications between vehicles are also referred to as V2V (vehicle to vehicle) communications. For example, as shown in FIG. 2, sensor data generated by other vehicle(s) 250 can be communicated to vehicle perception and planning system 220 and/or vehicle onboard LiDAR system(s) 210, via communication path 253 and/or communication path 251, respectively. Communication paths 253 and 251 can be any wired or wireless communication links that can transfer data.

Sharing sensor data facilitates a better perception of the environment external to the vehicles. For instance, a first vehicle may not sense a pedestrian that is behind a second vehicle but is approaching the first vehicle. The second vehicle may share the sensor data related to this pedestrian with the first vehicle such that the first vehicle can have additional reaction time to avoid collision with the pedestrian. In some embodiments, similar to data generated by sensor(s) 230, data generated by sensors onboard other vehicle(s) 250 may be correlated or fused with sensor data generated by LiDAR system(s) 210 (or with other LiDAR systems located in other vehicles), thereby at least partially offloading the sensor fusion process performed by vehicle perception and planning system 220.

In some embodiments, intelligent infrastructure system(s) 240 are used to provide sensor data separately or together with LiDAR system(s) 210. Certain infrastructures may be configured to communicate with a vehicle to convey information and vice versa. Communications between a vehicle and infrastructures are generally referred to as V2I (vehicle to infrastructure) communications. For example, intelligent infrastructure system(s) 240 may include an intelligent traffic light that can convey its status to an approaching vehicle in a message such as “changing to yellow in 5 seconds.” Intelligent infrastructure system(s) 240 may also include its own LiDAR system mounted near an intersection such that it can convey traffic monitoring information to a vehicle. For example, a left-turning vehicle at an intersection may not have sufficient sensing capabilities because some of its own sensors may be blocked by traffic in the opposite direction. In such a situation, sensors of intelligent infrastructure system(s) 240 can provide useful data to the left-turning vehicle. Such data may include, for example, traffic conditions, information of objects in the direction the vehicle is turning to, traffic light status and predictions, or the like. These sensor data generated by intelligent infrastructure system(s) 240 can be provided to vehicle perception and planning system 220 and/or vehicle onboard LiDAR system(s) 210, via communication paths 243 and/or 241, respectively. Communication paths 243 and/or 241 can include any wired or wireless communication links that can transfer data. For example, sensor data from intelligent infrastructure system(s) 240 may be transmitted to LiDAR system(s) 210 and correlated or fused with sensor data generated by LiDAR system(s) 210, thereby at least partially offloading the sensor fusion process performed by vehicle perception and planning system 220. V2V and V2I communications described above are examples of vehicle-to-X (V2X) communications, where the “X” represents any other devices, systems, sensors, infrastructure, or the like that can share data with a vehicle.

With reference still to FIG. 2, via various communication paths, vehicle perception and planning system 220 receives sensor data from one or more of LiDAR system(s) 210, other vehicle onboard sensor(s) 230, other vehicle(s) 250, and/or intelligent infrastructure system(s) 240. In some embodiments, different types of sensor data are correlated and/or integrated by a sensor fusion sub-system 222. For example, sensor fusion sub-system 222 can generate a 360-degree model using multiple images or videos captured by multiple cameras disposed at different positions of the vehicle. Sensor fusion sub-system 222 obtains sensor data from different types of sensors and uses the combined data to perceive the environment more accurately. For example, a vehicle onboard camera 232 may not capture a clear image because it is facing the sun or a light source (e.g., another vehicle's headlight during nighttime) directly. A LiDAR system 210 may not be affected as much and therefore sensor fusion sub-system 222 can combine sensor data provided by both camera 232 and LiDAR system 210, and use the sensor data provided by LiDAR system 210 to compensate the unclear image captured by camera 232. As another example, in a rainy or foggy weather, a radar sensor 234 may work better than a camera 232 or a LiDAR system 210. Accordingly, sensor fusion sub-system 222 may use sensor data provided by the radar sensor 234 to compensate the sensor data provided by camera 232 or LiDAR system 210.

In other examples, sensor data generated by other vehicle onboard sensor(s) 230 may have a lower resolution (e.g., radar sensor data) and thus may need to be correlated and confirmed by LiDAR system(s) 210, which usually has a higher resolution. For example, a sewage cover (also referred to as a manhole cover) may be detected by radar sensor 234 as an object towards which a vehicle is approaching. Due to the low-resolution nature of radar sensor 234, vehicle perception and planning system 220 may not be able to determine whether the object is an obstacle that the vehicle needs to avoid. High-resolution sensor data generated by LiDAR system(s) 210 thus can be used to correlated and confirm that the object is a sewage cover and causes no harm to the vehicle.

Vehicle perception and planning system 220 further comprises an object classifier 223. Using raw sensor data and/or correlated/fused data provided by sensor fusion sub-system 222, object classifier 223 can use any computer vision techniques to detect and classify the objects and estimate the positions of the objects. In some embodiments, object classifier 223 can use machine-learning based techniques to detect and classify objects. Examples of the machine-learning based techniques include utilizing algorithms such as region-based convolutional neural networks (R-CNN), Fast R-CNN, Faster R-CNN, histogram of oriented gradients (HOG), region-based fully convolutional network (R-FCN), single shot detector (SSD), spatial pyramid pooling (SPP-net), and/or You Only Look Once (Yolo).

Vehicle perception and planning system 220 further comprises a road detection sub-system 224. Road detection sub-system 224 localizes the road and identifies objects and/or markings on the road. For example, based on raw or fused sensor data provided by radar sensor(s) 234, camera(s) 232, and/or LiDAR system(s) 210, road detection sub-system 224 can build a 3D model of the road based on machine-learning techniques (e.g., pattern recognition algorithms for identifying lanes). Using the 3D model of the road, road detection sub-system 224 can identify objects (e.g., obstacles or debris on the road) and/or markings on the road (e.g., lane lines, turning marks, crosswalk marks, or the like).

Vehicle perception and planning system 220 further comprises a localization and vehicle posture sub-system 225. Based on raw or fused sensor data, localization and vehicle posture sub-system 225 can determine position of the vehicle and the vehicle's posture. For example, using sensor data from LiDAR system(s) 210, camera(s) 232, and/or UPS data, localization and vehicle posture sub-system 225 can determine an accurate position of the vehicle on the road and the vehicle's six degrees of freedom (e.g., whether the vehicle is moving forward or backward, up or down, and left or right). In some embodiments, high-definition (RD) maps are used for vehicle localization. HD maps can provide highly detailed, three-dimensional, computerized maps that pinpoint a vehicle's location. For instance, using the HD maps, localization and vehicle posture sub-system 225 can determine precisely the vehicle's current position (e.g., which lane of the road the vehicle is currently in, how close it is to a curb or a sidewalk) and predict vehicle's future positions.

Vehicle perception and planning system 220 further comprises obstacle predictor 226. Objects identified by object classifier 223 can be stationary (e.g., a light pole, a road sign) or dynamic (e.g., a moving pedestrian, bicycle, another car). For moving objects, predicting their moving path or future positions can be important to avoid collision. Obstacle predictor 226 can predict an obstacle trajectory and/or warn the driver or the vehicle planning sub-system 228 about a potential collision. For example, if there is a high likelihood that the obstacle's trajectory intersects with the vehicle's current moving path, obstacle predictor 226 can generate such a warning. Obstacle predictor 226 can use a variety of techniques for making such a prediction. Such techniques include, for example, constant velocity or acceleration models, constant turn rate and velocity/acceleration models, Kalman Filter and Extended Kalman Filter based models, recurrent neural network (RNN) based models, long short-term memory (LSTM) neural network based models, encoder-decoder RNN models, or the like.

With reference still to FIG. 2, in some embodiments, vehicle perception and planning system 220 further comprises vehicle planning sub-system 228. Vehicle planning sub-system 228 can include one or more planners such as a route planner, a driving behaviors planner, and a motion planner. The route planner can plan the route of a vehicle based on the vehicle's current location data, target location data, traffic information, etc. The driving behavior planner adjusts the timing and planned movement based on how other objects might move, using the obstacle prediction results provided by obstacle predictor 226. The motion planner determines the specific operations the vehicle needs to follow. The planning results are then communicated to vehicle control system 280 via vehicle interface 270. The communication can he performed through communication paths 223 and 271, which include any wired or wireless communication links that can transfer data.

Vehicle control system 280 controls the vehicle's steering mechanism, throttle, brake, etc., to operate the vehicle according to the planned route and movement. In some examples, vehicle perception and planning system 220 may further comprise a user interface 260, which provides a user (e.g., a driver) access to vehicle control system 280 to, for example, override or take over control of the vehicle when necessary. User interface 260 may also be separate from vehicle perception and planning system 220. User interface 260 can communicate with vehicle perception and planning system 220, for example, to obtain and display raw or fused sensor data, identified objects, vehicle's location/posture, etc. These displayed data can help a user to better operate the vehicle, User interface 260 can communicate with vehicle perception and planning system 220 and/or vehicle control system 280 via communication paths 221 and 261 respectively, which include any wired or wireless communication links that can transfer data. It is understood that the various systems, sensors, communication links, and interfaces in FIG. 2 can be configured in any desired manner and not limited to the configuration shown in FIG. 2.

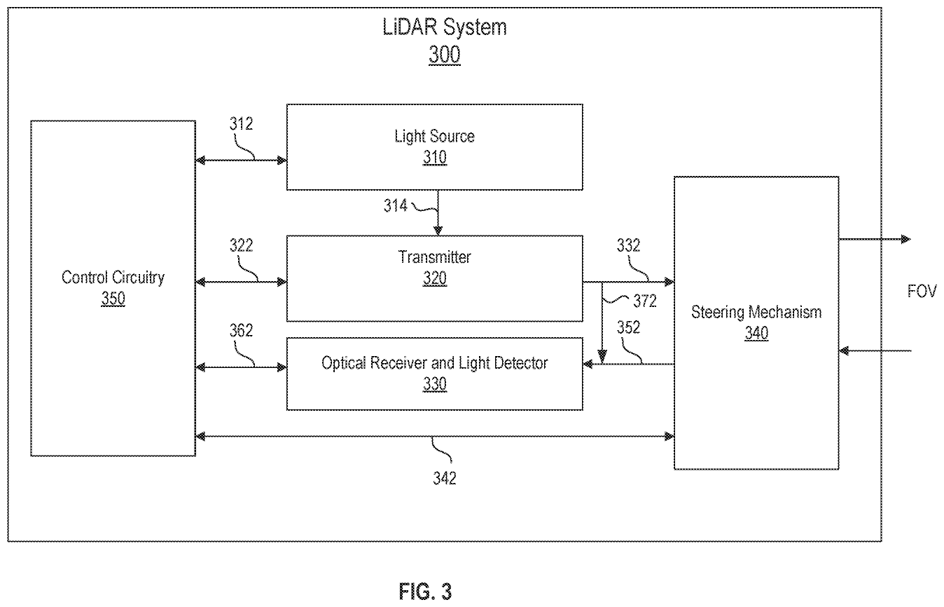

FIG. 3 is a block diagram illustrating an example LiDAR system 300. LiDAR system 300 can be used to implement LiDAR systems 110, 120A-120I, and/or 210 shown in FIGS. 1 and 2. In one embodiment, LiDAR system 300 comprises a light source 310, a transmitter 320, an optical receiver and light detector 330, a steering system 340, and a control circuitry 350. These components are coupled together using communications paths 312, 314, 322, 332, 342, 352, and 362. These communications paths include communication links (wired or wireless, bidirectional or unidirectional) among the various LiDAR system components, but need not be physical components themselves. While the communications paths can be implemented by one or more electrical wires, buses, or optical fibers, the communication paths can also be wireless channels or free-space optical paths so that no physical communication medium is present. For example, in one embodiment of LiDAR system 300, communication path 314 between light source 310 and transmitter 320 may be implemented using one or more optical fibers. Communication paths 332 and 352 may represent optical paths implemented using free space optical components and/or optical fibers. And communication paths 312, 322, 342, and 362 may be implemented using one or more electrical wires that carry electrical signals. The communications paths can also include one or more of the above types of communication mediums (e.g., they can include an optical fiber and a free-space optical component, or include one or more optical fibers and one or more electrical wires).

In some embodiments, LiDAR system 300 can be a coherent LiDAR system. One example is a frequency-modulated continuous-wave (FMCW) LiDAR. Coherent LiDARs detect objects by mixing return light from the objects with light from the coherent laser transmitter. Thus, as shown in FIG. 3, if LiDAR system 300 is a coherent LiDAR, it may include a route 372 providing a portion of transmission light from transmitter 320 to optical receiver and light detector 330. The transmission light provided by transmitter 320 may be modulated light and can be split into two portions. One portion is transmitted to the FOV, while the second portion is sent to the optical receiver and light detector of the LiDAR system. The second portion is also referred to as the light that is kept local (LO) to the LiDAR system. The transmission light is scattered or reflected by various objects in the FOV and at least a portion of it forms return light. The return light is subsequently detected and interferometrically recombined with the second portion of the transmission light that was kept local. Coherent LiDAR provides a means of optically sensing an object's range as well as its relative velocity along the line-of-sight (LOS).

LiDAR system 300 can also include other components not depicted in FIG. 3, such as power buses, power supplies, LED indicators, switches, etc. Additionally, other communication connections among components may be present, such as a direct connection between light source 310 and optical receiver and light detector 330 to provide a reference signal so that the time from when a light pulse is transmitted until a return light pulse is detected can be accurately measured.

Light source 310 outputs laser light for illuminating objects in a field of view (FOV). The laser light can be infrared light having a wavelength in the range of 700 nm to 1 mm. Light source 310 can be, for example, a semiconductor-based laser (e.g., a diode laser) and/or a fiber-based laser. A semiconductor-based laser can be, for example, an edge emitting laser (EEL), a vertical cavity surface emitting laser (VCSEL), an external-cavity diode laser, a vertical-external-cavity surface-emitting laser, a distributed feedback (DFB) laser, a distributed Bragg reflector (DBR) laser, an interband cascade laser, a quantum cascade laser, a quantum well laser, a double heterostructure laser, or the like. A fiber-based laser is a laser in which the active gain medium is an optical fiber doped with rare-earth elements such as erbium, ytterbium, neodymium, dysprosium, praseodymium, thulium and/or holmium. In some embodiments, a fiber laser is based on double-clad fibers, in which the gain medium forms the core of the fiber surrounded by two layers of cladding. The double-clad fiber allows the core to be pumped with a high-power beam, thereby enabling the laser source to be a high power fiber laser source.

In some embodiments, light source 310 comprises a master oscillator (also referred to as a seed laser) and power amplifier (MOPA). The power amplifier amplifies the output power of the seed laser. The power amplifier can be a fiber amplifier, a bulk amplifier, or a semiconductor optical amplifier. The seed laser can be a diode laser (e.g., a Fabry-Perot cavity laser, a distributed feedback laser), a solid-state bulk laser, or a tunable external-cavity diode laser. In some embodiments, light source 310 can be an optically pumped microchip laser. Microchip lasers are alignment-free monolithic solid-state lasers where the laser crystal is directly contacted with the end mirrors of the laser resonator. A microchip laser is typically pumped with a laser diode (directly or using a fiber) to obtain the desired output power. A microchip laser can be based on neodymium-doped yttrium aluminum garnet (Y₃Al₅O₁₂) laser crystals (i.e., Nd:YAG), or neodymium-doped vanadate (i.e., ND:YVO₄) laser crystals. In some examples, light source 310 may have multiple amplification stages to achieve a high power gain such that the laser output can have high power, thereby enabling the LiDAR system to have a long scanning range. In some examples, the power amplifier of light source 310 can be controlled such that the power gain can be varied to achieve any desired laser output power.

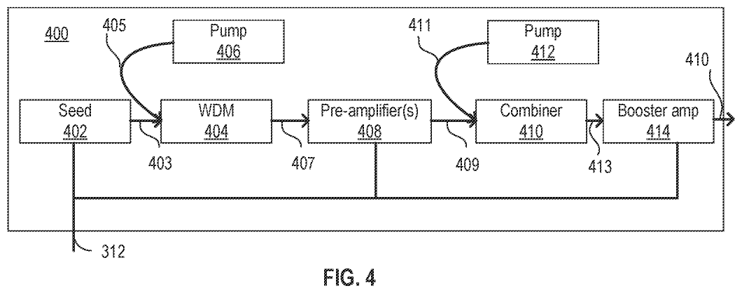

FIG. 4 is a block diagram illustrating an example fiber-based laser source 400 having a seed laser and one or more pumps (e.g., laser diodes) for pumping desired output power. Fiber-based laser source 400 is an example of light source 310 depicted in FIG. 3. In some embodiments, fiber-based laser source 400 comprises a seed laser 402 to generate initial light pulses of one or more wavelengths (e.g., infrared wavelengths such as 1550 nm), which are provided to a wavelength-division multiplexor (WDM) 404 via an optical fiber 403. Fiber-based laser source 400 further comprises a pump 406 for providing laser power (e.g., of a different wavelength, such as 980 nm) to WDM 404 via an optical fiber 405. WDM 404 multiplexes the light pulses provided by seed laser 402 and the laser power provided by pump 406 onto a single optical fiber 407. The output of WDM 404 can then be provided to one or more pre-amplifier(s) 408 via optical fiber 407. Pre-amplifier(s) 408 can be optical amplifier(s) that amplify optical signals (e.g., with about 10-30 dB gain). In some embodiments, pre-amplifier(s) 408 are low noise amplifiers. Pre-amplifier(s) 408 output to an optical combiner 410 via an optical fiber 409. Combiner 410 combines the output laser light of pre-amplifier(s) 408 with the laser power provided by pump 412 via an optical fiber 411. Combiner 410 can combine optical signals having the same wavelength or different wavelengths. One example of a combiner is a WDM. Combiner 410 provides combined optical signals to a booster amplifier 414, which produces output light pulses via optical fiber 410. The booster amplifier 414 provides further amplification of the optical signals (e.g., another 20-40 dB). The outputted light pulses can then be transmitted to transmitter 320 and/or steering mechanism 340 (shown in FIG. 3). It is understood that FIG. 4 illustrates one example configuration of fiber-based laser source 400, Laser source 400 can have many other configurations using different combinations of one or more components shown in FIG. 4 and/or other components not shown in FIG. 4 (e.g., other components such as power supplies, lens(es), filters, splitters, combiners, etc.).

In some variations, fiber-based laser source 400 can be controlled (e.g., by control circuitry 350) to produce pulses of different amplitudes based on the fiber gain profile of the fiber used in fiber-based laser source 400. Communication path 312 couples fiber-based laser source 400 to control circuitry 350 (shown in FIG. 3) so that components of fiber-based laser source 400 can be controlled by or otherwise communicate with control circuitry 350, Alternatively, fiber-based laser source 400 may include its own dedicated controller. Instead of control circuitry 350 communicating directly with components of fiber-based laser source 400, a dedicated controller of fiber-based laser source 400 communicates with control circuitry 350 and controls and/or communicates with the components of fiber-based laser source 400. Fiber-based laser source 400 can also include other components not shown, such as one or more power connectors, power supplies, and/or power lines.

Referencing FIG. 3, typical operating wavelengths of light source 310 comprise, for example, about 850 nm, about 905 nm, about 940 nm, about 1064 nm, and about 1550 nm. For laser safety, the upper limit of maximum usable laser power is set by the U.S. FDA (U.S. Food and Drug Administration) regulations. The optical power limit at 1550 nm wavelength is much higher than those of the other aforementioned wavelengths. Further, at 1550 nm, the optical power loss in a fiber is low. There characteristics of the 1550 nm wavelength make it more beneficial for long-range LiDAR applications. The amount of optical power output from light source 310 can be characterised by its peak power, average power, pulse energy, and/or the pulse energy density. The peak power is the ratio of pulse energy to the width of the pulse (e.g., full width at half maximum or FWHM). Thus, a smaller pulse width can provide a larger peak power for a fixed amount of pulse energy. A pulse width can be in the range of nanosecond or picosecond. The average power is the product of the energy of the pulse and the pulse repetition rate (PRR). As described in more detail below, the PRR represents the frequency of the pulsed laser light. In general, the smaller the time interval between the pulses, the higher the PRR. The PRR typically corresponds to the maximum range that a LiDAR system can measure. Light source 310 can be configured to produce pulses at high PRR to meet the desired number of data points in a point cloud generated by the LiDAR system. Light source 310 can also be configured to produce pulses at medium or low PRR to meet the desired maximum detection distance. Wall plug efficiency (WPE) is another factor to evaluate the total power consumption, which may be a useful indicator in evaluating the laser efficiency. For example, as shown in FIG. 1, multiple LiDAR systems may be attached to a vehicle, which may be an electrical-powered vehicle or a vehicle otherwise having limited fuel or battery power supply. Therefore, high WPE and intelligent ways to use laser power are often among the important considerations when selecting and configuring light source 310 and/or designing laser delivery systems for vehicle-mounted LiDAR applications.

It is understood that the above descriptions provide non-limiting examples of a light source 310. Light source 310 can be configured to include many other types of light sources (e.g., laser diodes, short-cavity fiber lasers, solid-state lasers, and/or tunable external cavity diode lasers) that are configured to generate one or more light signals at various wavelengths. In some examples, light source 310 comprises amplifiers (e.g., pre-amplifiers and/or booster amplifiers), which can be a doped optical fiber amplifier, a solid-state bulk amplifier, and/or a semiconductor optical amplifier. The amplifiers are configured to receive and amplify light signals with desired gains.

With reference back to FIG. 3, LiDAR system 300 further comprises a transmitter 320. Light source 310 provides laser light (e.g., in the form of a laser beam) to transmitter 320. The laser light provided by light source 310 can be amplified laser light with a predetermined or controlled wavelength, pulse repetition rate, and/or power level. Transmitter 320 receives the laser light from light source 310 and transmits the laser light to steering mechanism 340 with low divergence. In some embodiments, transmitter 320 can include, for example, optical components (e.g., lens, fibers, minors, etc.) for transmitting one or more laser beams to a field-of-view (FOV) directly or via steering mechanism 340. While FIG. 3 illustrates transmitter 320 and steering mechanism 340 as separate components, they may be combined or integrated as one system in some embodiments. Steering mechanism 340 is described in more detail below.

Laser beams provided by light source 310 may diverge as they travel to transmitter 320. Therefore, transmitter 320 often comprises a collimating lens configured to collect the diverging laser beams and produce more parallel optical beams with reduced or minimum divergence. The collimated optical beams can then be further directed through various optics such as mirrors and lens. A collimating lens may be, for example, a single plano-convex lens or a lens group. The collimating lens can be configured to achieve any desired properties such as the beam diameter, divergence, numerical aperture, focal length, or the like. A beam propagation ratio or beam quality factor (also referred to as the M² factor) is used for measurement of laser beam quality. In many LiDAR applications, it is important to have good laser beam quality in the generated transmitting laser beam. The M² factor represents a degree of variation of a beam from an ideal Gaussian beam. Thus, the M² factor reflects how well a collimated laser beam can be focused on a small spot, or how well a divergent laser beam can be collimated. Therefore, light source 310 and/or transmit ear 320 can be configured to meet, for example, a scan resolution requirement while maintaining the desired M² factor.

One or more of the light beams provided by transmitter 320 are scanned by steering mechanism 340 to a FOV. Steering mechanism 340 scans light beams in multiple dimensions (e.g., in both the horizontal and vertical dimension) to facilitate LiDAR system 300 to map the environment by generating a 3D point cloud. A horizontal dimension can be a dimension that is parallel to the horizon or a surface associated with the LiDAR system or a vehicle (e.g., a road surface). A vertical dimension is perpendicular to the horizontal dimension (i.e., the vertical dimension forms a 90-degree angle with the horizontal dimension). Steering mechanism 340 will be described in more detail below. The laser light scanned to an FOV may be scattered or reflected by an object in the FOV. At least a portion of the scattered or reflected light forms return light that returns to LiDAR system 300. FIG. 3 further illustrates an optical receiver and light detector 330 configured to receive the return light. Optical receiver and light detector 330 comprises an optical receiver that is configured to collect the return light from the FOV. The optical receiver can include optics (e.g., lens, fibers, mirrors, etc.) for receiving, redirecting, focusing, amplifying, and/or filtering return light from the FOV. For example, the optical receiver often includes a collection lens (e.g., a single planoconvex lens or a lens group) to collect and/or focus the collected return light onto a light detector.

A light detector detects the return light focused by the optical receiver and generates current and/or voltage signals proportional to the incident intensity of the return light. Based on such current and/or voltage signals, the depth information of the object in the FOV can be derived. One example method for deriving such depth information is based on the direct TOF (time of flight), which is described in more detail below. A light detector may be characterized by its detection sensitivity, quantum efficiency, detector bandwidth, linearity, signal to noise ratio (SNR), overload resistance, interference immunity, etc. Based on the applications, the light detector can be configured or customized to have any desired characteristics. For example, optical receiver and light detector 330 can be configured such that the light detector has a large dynamic range while having a good linearity. The light detector linearity indicates the detector's capability of maintaining linear relationship between input optical signal power and the detector's output. A detector having good linearity can maintain a linear relationship over a large dynamic input optical signal range.

To achieve desired detector characteristics, configurations or customizations can be made to the light detector's structure and/or the detector's material system. Various detector structure can be used for a light detector. For example, a light detector structure can be a PIN based structure, which has a undoped intrinsic semiconductor region (i.e., an “i” region) between a p-type semiconductor and an n-type semiconductor region. Other light detector structures comprise, for example, an APD (avalanche photodiode) based structure, a PMT (photomultiplier tube) based structure, a SiPM (Silicon photomultiplier) based structure, a SPAD (single-photon avalanche diode) based structure, and/or quantum wires. For material systems used in a light detector, Si, InGaAs, and/or Si/Ge based materials can be used. It is understood that many other detector structures and/or material systems can be used in optical receiver and light detector 330.

A light detector (e.g., an APD based detector) may have an internal gain such that the input signal is amplified when generating an output signal. However, noise may also be amplified due to the light detector's internal gain. Common types of noise include signal shot noise, dark current shot noise, thermal noise, and amplifier noise. In some embodiments, optical receiver and light detector 330 may include a pre-amplifier that is a low noise amplifier (LNA). In some embodiments, the pre-amplifier may also include a transimpedance amplifier (TIA), which converts a current signal to a voltage signal. For a linear detector system, input equivalent noise or noise equivalent power (NEP) measures how sensitive the light detector is to weak signals. Therefore, they can be used as indicators of the overall system performance. For example, the NEP of a light detector specifies the power of the weakest signal that can be detected and therefore it in turn specifies the maximum range of a LiDAR system. It is understood that various light detector optimization techniques can be used to meet the requirement of LiDAR system 300. Such optimization techniques may include selecting different detector structures, materials, and/or implementing signal processing techniques (e.g., filtering, noise reduction, amplification, or the like). For example, in addition to, or instead of, using direct detection of return signals (e.g., by using ToF), coherent detection can also be used for a light detector. Coherent detection allows for detecting amplitude and phase information of the received light by interfering the received light with a local oscillator. Coherent detection can improve detection sensitivity and noise immunity.

FIG. 3 further illustrates that LiDAR system 300 comprises steering mechanism 340. As described above, steering mechanism 340 directs light beams from transmitter 320 to scan an FOV in multiple dimensions. A steering mechanism is referred to as a raster mechanism, a scanning mechanism, or simply a light scanner. Scanning light beams in multiple directions (e.g., in both the horizontal and vertical directions) facilitates a LiDAR system to map the environment by generating an image or a 3D point cloud. A steering mechanism can be based on mechanical scanning and/or solid-state scanning. Mechanical scanning uses rotating mirrors to steer the laser beam or physically rotate the LiDAR transmitter and receiver (collectively referred to as transceiver) to scan the laser beam. Solid-state scanning directs the laser beam to various positions through the FOV without mechanically moving any macroscopic components such as the transceiver. Solid-state scanning mechanisms include, for example, optical phased arrays based steering and flash LiDAR based steering. In some embodiments, because solid-state scanning mechanisms do not physically move macroscopic components, the steering performed by a solid-state scanning mechanism may be referred to as effective steering. A LiDAR system using solid-state scanning may also be referred to as a non-mechanical scanning or simply non-scanning LiDAR system (a flash LiDAR system is an example non-scanning LiDAR system).

Steering mechanism 340 can be used with a transceiver (e.g., transmitter 320 and optical receiver and light detector 330) to scan the FOV for generating an image or a 3D point cloud. As an example, to implement steering mechanism 340, a two-dimensional mechanical scanner can be used with a single-point or several single-point transceivers. A single-point transceiver transmits a single light beam or a small number of light beams (e.g., 2-8 beams) to the steering mechanism. A two-dimensional mechanical steering mechanism comprises, for example, polygon mirror(s), oscillating mirror(s), rotating prism(s), rotating tilt mirror surface(s), single-plane or multi-plane mirror(s), or a combination thereof. In some embodiments, steering mechanism 340 may include non-mechanical steering mechanism(s) such as solid-state steering mechanism(s). For example, steering mechanism 340 can be based on tuning wavelength of the laser light combined with refraction effect, and/or based on reconfigurable grating/phase array. In some embodiments, steering mechanism 340 can use a single scanning device to achieve two-dimensional scanning or multiple scanning devices combined to realize two-dimensional scanning.

As another example, to implement steering mechanism 340, a one-dimensional mechanical scanner can be used with an array or a large number of single-point transceivers. Specifically, the transceiver array can be mounted on a rotating platform to achieve 360-degree horizontal field of view. Alternatively, a static transceiver array can be combined with the one-dimensional mechanical scanner. A one-dimensional mechanical scanner comprises polygon mirror(s), oscillating mirror(s), rotating prism(s), rotating tilt mirror surface(s), or a combination thereof, for obtaining a forward-looking horizontal field of view. Steering mechanisms using mechanical scanners can provide robustness and reliability in high volume production for automotive applications.

As another example, to implement steering mechanism 340, a two-dimensional transceiver can be used to generate a scan image or a 3D point cloud directly. In some embodiments, a stitching or micro shift method can be used to improve the resolution of the scan image or the field of view being scanned. For example, using a two-dimensional transceiver, signals generated at one direction (e.g., the horizontal direction) and signals generated at the other direction (e.g., the vertical direction) may be integrated, interleaved, and/or matched to generate a higher or full resolution image or 3D point cloud representing the scanned FOV.

Some implementations of steering mechanism 340 comprise one or more optical redirection elements (e.g., mirrors or lenses) that steer return light signals (e.g., by rotating, vibrating, or directing) along a receive path to direct the return light signals to optical receiver and light detector 330. The optical redirection elements that direct light signals along the transmitting and receiving paths may be the same components (e.g., shared), separate components (e.g., dedicated), and/or a combination of shared and separate components. This means that in some cases the transmitting and receiving paths are different although they may partially overlap (or in some cases, substantially overlap or completely overlap).

With reference still to FIG. 3, LiDAR system 300 further comprises control circuitry 350. Control circuitry 350 can be configured and/or programmed to control various parts of the LiDAR system 300 and/or to perform signal processing. In a typical system, control circuitry 350 can be configured and/or programmed to perform one or more control operations including, for example, controlling light source 310 to obtain the desired laser pulse timing, the pulse repetition rate, and power; controlling steering mechanism 340 (e.g., controlling the speed, direction, and/or other parameters) to scan the FOV and maintain pixel registration and/or alignment; controlling optical receiver and light detector 330 (e.g., controlling the sensitivity, noise reduction, filtering, and/or other parameters) such that it is an optimal state; and monitoring overall system health/status for functional safety (e.g., monitoring the laser output power and/or the steering mechanism operating status for safety).

Control circuitry 350 can also be configured and/or programmed to perform signal processing to the raw data generated by optical receiver and light detector 330 to derive distance and reflectance information, and perform data packaging and communication to vehicle perception and planning system 220 (shown in FIG. 2). For example, control circuitry 350 determines the time it takes from transmitting a light pulse until a corresponding return light pulse is received; determines when a return light pulse is not received for a transmitted light pulse; determines the direction (e.g., horizontal and/or vertical information) for a transmitted/return light pulse; determines the estimated range in a particular direction; derives the reflectivity of an object in the FOV, and/or determines any other type of data relevant to LiDAR system 300.

LiDAR system 300 can be disposed in a vehicle, which may operate in many different environments including hot or cold weather, rough road conditions that may cause intense vibration, high or low humidities, dusty areas, etc. Therefore, in some embodiments, optical and/or electronic components of LiDAR system 300 (e.g., optics in transmitter 320, optical receiver and light detector 330, and steering mechanism 340) are disposed and/or configured in such a manner to maintain long term mechanical and optical stability. For example, components in LiDAR system 300 may be secured and sealed such that they can operate under all conditions a vehicle may encounter. As an example, an anti-moisture coating and/or hermetic sealing may, be applied to optical components of transmitter 320, optical receiver and light detector 330, and steering mechanism 340 (and other components that are susceptible to moisture). As another example, housing(s), enclosure(s), fairing(s), and/or window can be used in LiDAR system 300 for providing desired characteristics such as hardness, ingress protection (IP) rating, self-cleaning capability, resistance to chemical and resistance to impact, or the like. In addition, efficient and economical methodologies for assembling LiDAR system 300 may be used to meet the LiDAR operating requirements while keeping the cost low.

It is understood by a person of ordinary skill in the art that FIG. 3 and the above descriptions are for illustrative purposes only, and a LiDAR system can include other functional units, blocks, or segments, and can include variations or combinations of these above functional units, blocks, or segments. For example, LiDAR system 300 can also include other components not depicted in FIG. 3, such as power buses, power supplies, LED indicators, switches, etc. Additionally, other connections among components may be present, such as a direct connection between light source 310 and optical receiver and light detector 330 so that light detector 330 can accurately measure the time from when light source 310 transmits a light pulse until light detector 330 detects a return light pulse.

These components shown in FIG. 3 are coupled together using communications paths 312, 314, 322, 332, 342, 352, and 362. These communications paths represent communication (bidirectional or unidirectional) among the various LiDAR system components but need not be physical components themselves. While the communications paths can be implemented by one or more electrical wires, busses, or optical fibers, the communication paths can also be wireless channels or open-air optical paths so that no physical communication medium is present. For example, in one example LiDAR system, communication path 314 includes one or more optical fibers; communication path 352 represents an optical path; and communication paths 312, 322, 342, and 362 are all electrical wires that carry electrical signals. The communication paths can also include more than one of the above types of communication mediums (e.g., they can include an optical fiber and an optical path, or one or more optical fibers and one or more electrical wires).

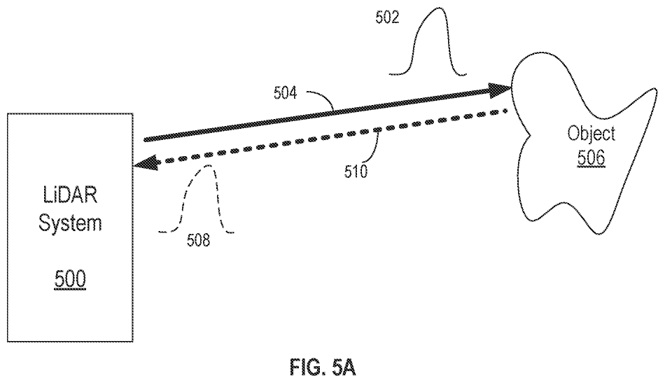

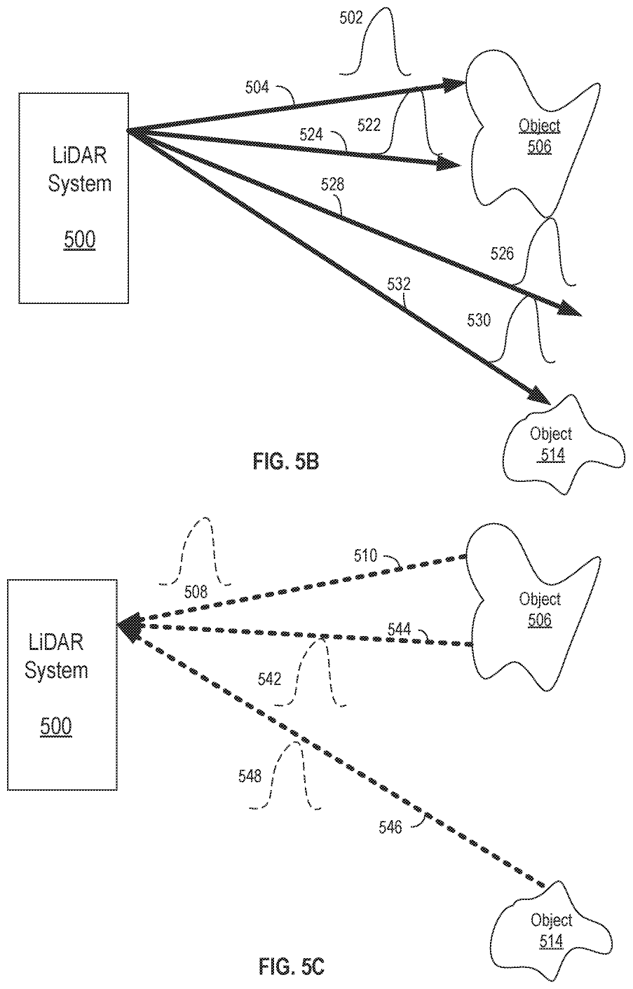

As described above, some LiDAR systems use the time-of-flight (ToF) of light signals (e.g., light pulses) to determine the distance to objects in a light path. For example, with reference to FIG. 5A, an example LiDAR system 500 includes a laser light source (e.g., a fiber laser), a steering mechanism (e.g., a system of one or more moving mirrors), and a light detector (e.g., a photodetector with one or more optics). LiDAR system 500 can be implemented using, for example, LiDAR system 300 described above. LiDAR system 500 transmits a light pulse 502 along light path 504 as determined by the steering mechanism of LiDAR system 500. In the depicted example, light pulse 502, which is generated by the laser light source, is a short pulse of laser light. Further, the signal steering mechanism of the LiDAR system 500 is a pulsed-signal steering mechanism. However, it should be appreciated that LiDAR systems can operate by generating, transmitting, and detecting light signals that are not pulsed and derive ranges to an object in the surrounding environment using techniques other than time-of-flight. For example, some LiDAR systems use frequency modulated continuous waves (i.e., “FMCW”). It should be further appreciated that any of the techniques described herein with respect to time-of-flight based systems that use pulsed signals also may be applicable to LiDAR systems that do not use one or both of these techniques.

Referring back to FIG. 5A (e.g., illustrating a time-of-flight LiDAR system that uses light pulses), when light pulse 502 reaches object 506, light pulse 502 scatters or reflects to form a return light pulse 508. Return light pulse 508 may return to system 500 along light path 510. The time from when transmitted light pulse 502 leaves LiDAR system 500 to when return light pulse 508 arrives back at LiDAR system 500 can be measured (e.g., by a processor or other electronics, such as control circuitry 350, within the LiDAR system). This time-of-flight combined with the knowledge of the speed of light can be used to determine the range/distance from LiDAR system 500 to the portion of object 506 where light pulse 502 scattered or reflected.

By directing many light pulses, as depicted in FIG. 5B, LiDAR system 500 scans the external environment (e.g., by directing light pulses 502, 522, 526, 530 along light paths 504, 524, 528, 532, respectively). As depicted in FIG. 5C, LiDAR system 500 receives return light pulses 508, 542, 548 (which correspond to transmitted light pulses 502, 522, 530, respectively). Return light pulses 508, 542, and 548 are formed by scattering or reflecting the transmitted light pulses by one of objects 506 and 514. Return light pulses 508, 542, and 548 may return to LiDAR system 500 along light paths 510, 544, and 546, respectively. Based on the direction of the transmitted light pulses (as determined by LiDAR system 500) as well as the calculated range from LiDAR system 500 to the portion of objects that scatter or reflect the light pulses (e.g., the portions of objects 506 and 514), the external environment within the detectable range (e.g., the field of view between path 504 and 532, inclusively) can be precisely mapped or plotted (e.g., by generating a 3D point cloud or images).

If a corresponding light pulse is not received for a particular transmitted light pulse, then LiDAR system 500 may determine that there are no objects within a detectable range of LiDAR system 500 (e.g., an object is beyond the maximum scanning distance of LiDAR system 500). For example, in FIG. 5B, light pulse 526 may not have a corresponding return light pulse (as illustrated in FIG. 5C) because light pulse 526 may not produce a scattering event along its transmission path 528 within the predetermined detection range. LiDAR system 500, or an external system in communication with LiDAR system 500 (e.g., a cloud system or service), can interpret the lack of return light pulse as no object being disposed along light path 528 within the detectable range of LiDAR system 500.

In FIG. 5B, light pulses 502, 522, 526, and 530 can be transmitted in any order, serially, in parallel, or based on other timings with respect to each other. Additionally, while FIG. 5B depicts transmitted light pulses as being directed in one dimension or one plane(e.g., the plane of the paper), LiDAR system 500 can also direct transmitted light pulses along other dimension(s) or plane(s). For example, LiDAR system 500 can also direct transmitted light pulses in a dimension or plane that is perpendicular to the dimension or plane shown in FIG. 5B, thereby forming a 2-dimensional transmission of the light pulses. This 2-dimensional transmission of the light pulses can be point-by-point, line-by-line, all at once, or in some other manner. That is, LiDAR system 500 can be configured to perform a point scan, a line scan, a one-shot without scanning, or a combination thereof A point cloud or image from a 1-dimensional transmission of light pulses (e.g., a single horizontal line) can generate 2-dimensional data (e.g., (1) data from the horizontal transmission direction and (2) the range or distance to objects). Similarly, a point cloud or image from a 2-dimensional transmission of light pulses can generate 3-dimensional data (e.g., (1) data from the horizontal transmission direction, (2) data from the vertical transmission direction, and (3) the range or distance to objects). In general, a LiDAR system performing an n-dimensional transmission of light pulses generates (n+1) dimensional data. This is because the LiDAR system can measure the depth of an object or the range/distance to the object, which provides the extra dimension of data. Therefore, a 2D scanning by a LiDAR system can generate a 3D point cloud for mapping the external environment of the LiDAR system.

The density of a point cloud refers to the number of measurements (data points) per area performed by the LiDAR system. A point cloud density relates to the LiDAR scanning resolution. Typically, a larger point cloud density, and therefore a higher resolution, is desired at least for the region of interest (ROI). The density of points in a point cloud or image generated by a LiDAR system is equal to the number of pulses divided by the field of view. In some embodiments, the field of view can be fixed. Therefore; to increase the density of points generated by one set of transmission-receiving optics (or transceiver optics), the LiDAR system may need to generate a pulse more frequently. In other words, a light source in the LiDAR system may have a higher pulse repetition rate (PRR). On the other hand, by generating and transmitting pulses more frequently, the farthest distance that the LiDAR system can detect may be limited. For example, if a return signal from a distant object is received after the system transmits the next pulse, the return signals may be detected in a different order than the order in which the corresponding signals are transmitted, thereby causing ambiguity if the system cannot correctly correlate the return signals with the transmitted signals.

To illustrate, consider an example LiDAR system that can transmit laser pulses with a pulse repetition rate between 500 kHz and 1 MHz. Based on the time it takes for a pulse to return to the LiDAR system and to avoid mix-up of return pulses from consecutive pulses in a typical LiDAR design, the farthest distance the LiDAR system can detect may be 300 meters and 150 meters for 500 kHz and 1 MHz, respectively. The density of points of a LiDAR system with 500 kHz repetition rate is half of that with 1 MHz. Thus, this example demonstrates that, if the system cannot correctly correlate return signals that arrive out of order, increasing the repetition rate from 500 kHz to 1 MHz (and thus improving the density of points of the system) may reduce the detection range of the system. Various techniques are used to mitigate the tradeoff between higher PRR and limited detection range. For example, multiple wavelengths can be used for detecting objects in different ranges. Optical and/or signal processing techniques (e.g., pulse encoding techniques) are also used to correlate between transmitted and return light signals.

Various systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Various systems, apparatus, and methods described herein may be implemented using computers operating in a client-server relationship. Typically, in such a system, the client computers are located remotely from the server computers and interact via a network. The client-server relationship may be defined and controlled by computer programs running on the respective client and server computers. Examples of client computers can include desktop computers, workstations, portable computers, cellular smartphones, tablets, or other types of computing devices.

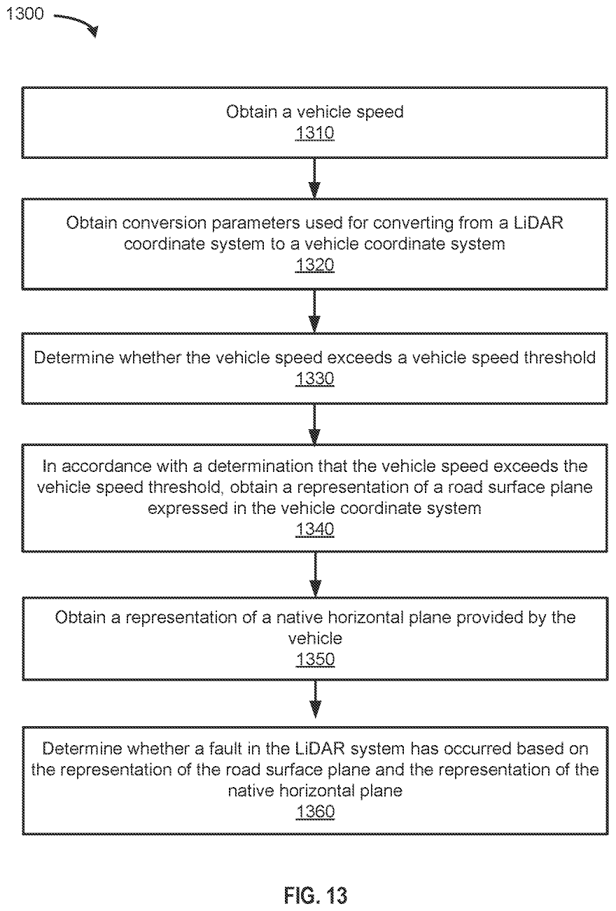

Various systems, apparatus, and methods described herein may be implemented using a computer program product tangibly embodied in an information carrier, e.g., in a non-transitory machine-readable storage device, for execution by a programmable processor; and the method processes and steps described herein, including one or more of the steps of FIG. 13, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

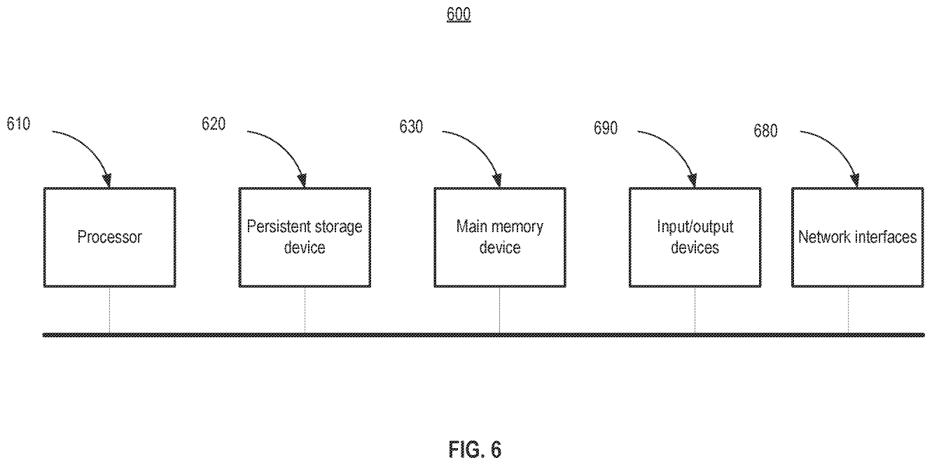

A high-level block diagram of an example apparatus that may be used to implement systems, apparatus and methods described herein is illustrated in FIG. 6. Apparatus 600 comprises a processor 610 operatively coupled to a persistent storage device 620 and a main memory device 630. Processor 610 controls the overall operation of apparatus 600 by executing computer program instructions that define such operations. The computer program instructions may be stored in persistent storage device 620, or other computer-readable medium, and loaded into main memory device 630 when execution of the computer program instructions is desired. For example, processor 610 may be used to implement one or more components and systems described herein, such as control circuitry 350 (shown in FIG. 3), vehicle perception and planning system 220 (shown in FIG. 2), and vehicle control system 280 (shown in FIG. 2). Thus, the method steps of FIG. 13 can be defined by the computer program instructions stored in main memory device 630 and/or persistent storage device 620 and controlled by processor 610 executing the computer program instructions. For example, the computer program instructions can be implemented as computer executable code programmed by one skilled in the art to perform an algorithm defined by the method steps discussed herein in connection with FIG. 13. Accordingly, by executing the computer program instructions, the processor 610 executes an algorithm defined by the method steps of these aforementioned figures. Apparatus 600 also includes one or more network interfaces 680 for communicating with other devices via a network. Apparatus 600 may also include one or more input/output devices 690 that enable user interaction with apparatus 600 (e.g., display, keyboard, mouse, speakers, buttons, etc.).

Processor 610 may include both general and special purpose microprocessors and may be the sole processor or one of multiple processors of apparatus 600. Processor 610 may comprise one or more central processing units (CPUs), and one or more graphics processing units (GPUs), which, for example, may work separately from and/or multi-task with one or more CPUs to accelerate processing, e.g., for various image processing applications described herein. Processor 610, persistent storage device 620, and/or main memory device 630 may include, be supplemented by, or incorporated in, one or more application-specific integrated circuits (ASICs) and/or one or more field programmable gate arrays (FPGAs).

Persistent storage device 620 and main memory device 630 each comprise a tangible non-transitory computer readable storage medium. Persistent storage device 620, and main memory device 630, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 690 may include peripherals, such as a printer, scanner, display screen, etc. For example, input/output devices 690 may include a display device such as a cathode ray tube (CRT), plasma or liquid crystal display (LCD) monitor for displaying information to a user, a keyboard, and a pointing device such as a mouse or a trackball by which the user can provide input to apparatus 600.

Any or all of the functions of the systems and apparatuses discussed herein may be performed by processor 610, and/or incorporated in, an apparatus or a system such as LiDAR system 300. Further, LiDAR system 300 and/or apparatus 600 may utilize one or more neural networks or other deep-learning techniques performed by processor 610 or other systems or apparatuses discussed herein.

One skilled in the art will recognize that an implementation of an actual computer or computer system may have other structures and may contain other components as well, and that FIG. 6 is a high-level representation of some of the components of such a computer for illustrative purposes.

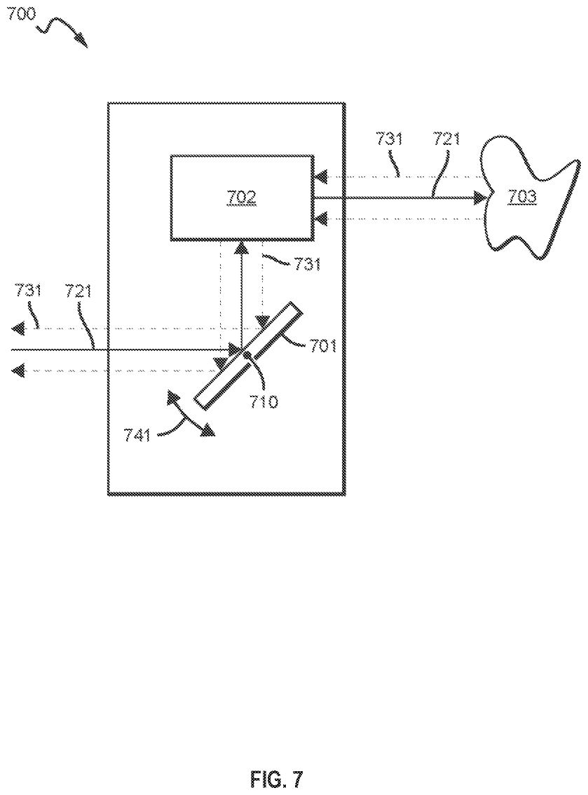

FIG. 7 is a block diagram illustrating an exemplary arrangement of components in a steering mechanism 700 of a LiDAR system according to one embodiment. Steering mechanism 700, which can be similar to steering mechanism 340 illustrated in FIG. 3, directs light beams from transmitter 320 to scan an FOV in multiple dimensions (e.g., in horizontal and vertical dimensions). Steering mechanism 700 includes a first mirror 701 and a second mirror 702. First mirror 701 scans in the vertical direction of the FOV, and second mirror 702 scans in the horizontal direction of the FOV. In other embodiments, first mirror 701 may scan in the horizontal direction and second mirror 702 may scan in the vertical direction of the FOV. First mirror 701 can be a galvanometer mirror or an oscillating mirror. First mirror 701 can have single or multiple planes. Second mirror 702 can be a polygon mirror, an oscillating mirror, a galvanometer mirror, a rotating prism, rotating tilt mirror surface, or single-plane or multi-plane mirror, etc. Second mirror 702 may include multiple aforementioned mirrors or a combination thereof.

As illustrated in FIG. 3, transmitter 320 receives laser light from light source 310 and transmits the laser light to steering mechanism 340 via communication path 332. In some embodiments, transmitter 320 and steering mechanism 340 may be combined or integrated as one component. In FIG. 7, the laser light coming from transmitter 320 via communication path 332 is depicted as outgoing light beam 721. In steering mechanism 700, outgoing light beam 721 is first directed to first mirror 701, then reflected by first mirror 701 to second minor 702, and then directed by second mirror 702 to illuminate object 703 in the FOV. In other embodiments of steering mechanism, the positions of first mirror 701 and second mirror 702 may be switched. Second mirror 702 may be a galvanometer mirror or an oscillating mirror, and first mirror 701 may be a polygon mirror, an oscillating mirror, a galvanometer mirror, a rotating prism, rotating tilt mirror surface, single-plane or multi-plane mirror, etc., or a combination thereof.

First mirror 701 (also “galvanometer mirror 701” or “mirror 701” hereinafter) is controlled to oscillate about axis 710. The oscillation of galvanometer mirror 701 facilitates the scanning of light beams along one dimension (e.g., the vertical dimension) of an FOV. Galvanometer mirror 701 reflects outgoing light beam 721 and directs the same toward second mirror 702. Through the movement of second mirror 702, e.g., rotating or oscillating, second mirror 702. scans outgoing light beam 721 along a second dimension of the FOV. For example, if galvanometer mirror 701 scans in the vertical dimension of the FOV, second 702 may scan in the horizontal dimension of the FOV, or vice versa. Second mirror 702 then directs outgoing light beam 721 to illuminate one or more objects (e.g., object 703) in the FOV.

First mirror 701 and second mirror 702 are used for both transmitting light beams to illuminate objects in an FOV and for receiving and redirecting return light to optical receiver and light detector 330. When outgoing light beam 721 travels to illuminate object 703 in the FOV, at least a portion of the light beam is reflected or scattered by object 703 to form return light 731. Return light 731 is received by second mirror 702 and is redirected (e.g., reflected) by second mirror 702 toward galvanometer mirror 701. Return light 731 is then redirected (e.g., reflected) by galvanometer mirror 701 to optical receiver and light detector 330 via communication path 352 (shown in FIG. 3).

Galvanometer mirror 701 can be controlled by, e.g., actuators or motors, to oscillate about axis 710. Mirror 701 oscillates back and forth between two end positions. Arrows 741 depict the directions of the oscillatory motion of mirror 701. As mirror 701 oscillates, its angular position can be used to describe its position at any given moment. Between the two end positions, mirror 701 oscillates back and forth around a center position, which is located at the midpoint of the two end positions. This angular position at the midpoint is referred to as 0°, zero position, or zero position angle, of galvanometer mirror 701. By oscillating between the two end positions, mirror 701 scans the outgoing light to cover a vertical range of the FOV, which can be about or greater than 25 degrees, e.g., about 30 degrees, 50 degrees, or 75 degrees, etc.

There is a direct relationship between the angular range of galvanometer mirror 701 and the vertical range of the FOV, which is also expressed in angular format. The greater the angular range of the oscillatory motion of mirror 701, the wider the vertical range of the FOV that can be scanned by the LiDAR system. However, it is to be noted that the two angular ranges may or may not be the same. In some embodiments, the two angular ranges are the same. For example, the angular ranges of the galvanometer mirror and the vertical range of the FOV can both be from −15° to −15°. In other embodiments, the two angular ranges are different. For example, a galvanometer mirror's angular range can be from −5° to −5°, but the vertical range of the FOV may range from −15° to −15°. Nevertheless, the angular position of 0° for the galvanometer mirror aligns with the vertical center position of the FOV.

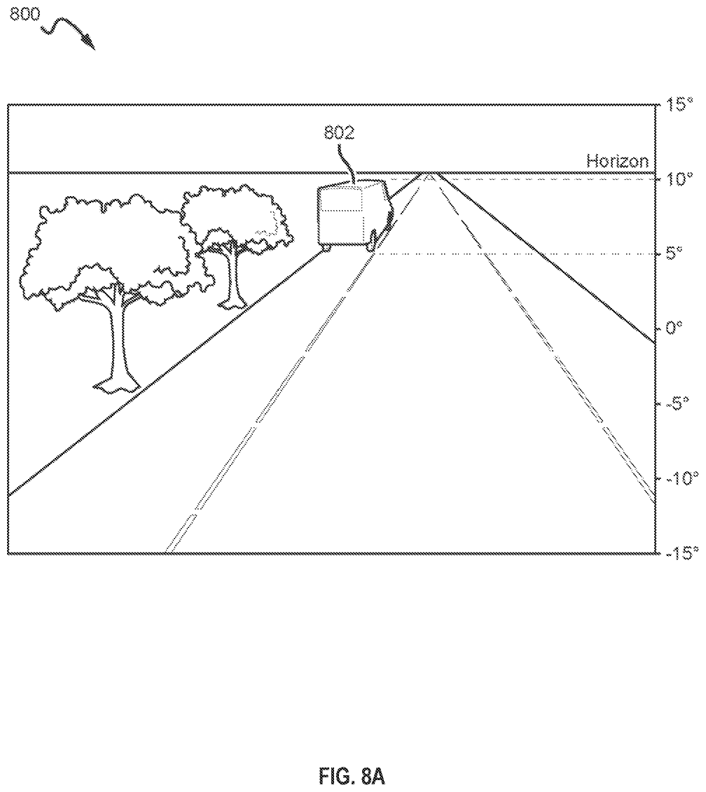

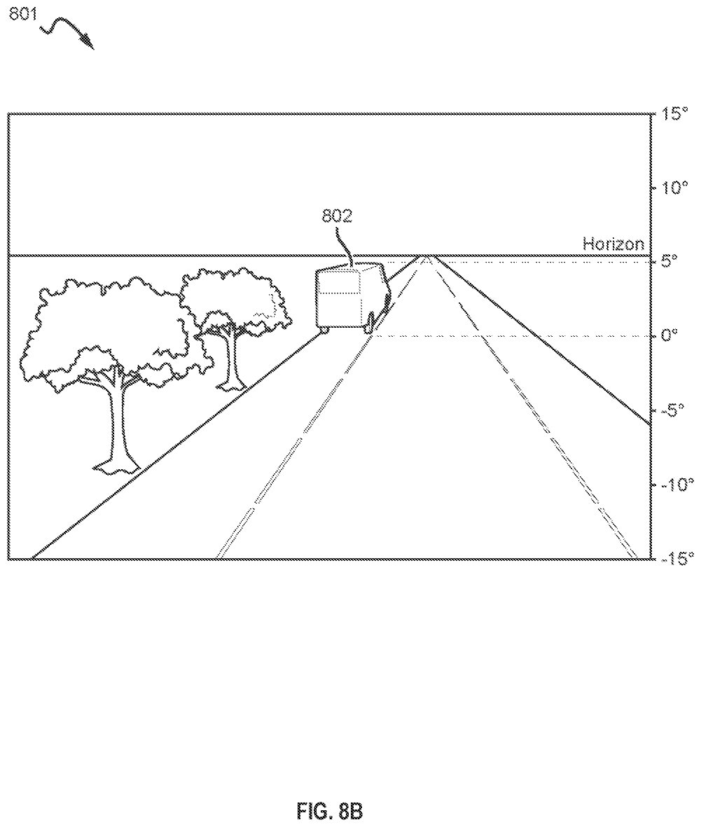

FIG. 8A illustrates LiDAR view 800 of a road scene when the zero angle position of the galvanometer mirror in the LiDAR system is not shifted. LiDAR view 800 is a 3D point cloud view of the external environment perceived by the LiDAR system. The LiDAR system can be mounted on the vehicle's rooftop. In other embodiments, the LiDAR system can be mounted on, or integrated to, a vehicle at any locations (e.g., rear-view mirrors, pillars, front grille, and/or back bumpers, etc.). The angles displayed on the right-hand side of LiDAR view 800 represent the vertical angles of the FOV, spanning from −15° to 15°. This indicates that the FOV has a 30-degree vertical range.

Each vertical angle in LiDAR view 800 can be mapped to an angular position of galvanometer mirror 701 as it oscillates between its two end positions. The upper end (or the first end) of the two end positions of mirror 701 corresponds to the 15° vertical angle in LiDAR view 800, which is the upper boundary of the FOV's vertical range. The lower end (or the second end) of the two end positions of mirror 701 corresponds to the −15° vertical angle in LiDAR view 800, which is the lower boundary of the FOV's vertical range. The zero position of the galvanometer mirror corresponds to the 0° angle in LiDAR view 800, which is located at the center of the vertical view. Each point in LiDAR view 800 corresponds to a specific vertical angle within the field of view. For example, the points representing vehicle 802 correspond to a vertical range of 5° to 10° within the FOV.

As the zero angle position of galvanometer mirror 701 corresponds to the vertical location of 0° angle in LiDAR view 800, a shift in mirror 701's zero angle position can cause the 0° angle location of LiDAR view 800 to be shifted up or down. In FIG. 8A, the zero position of the galvanometer mirror is not shifted. The shift of galvanometer mirror's zero position may occur when there is a change in the mirror's position relative to the vehicle. As the LiDAR system is mounted on a vehicle, shocks or vibrations of the vehicle over time may result in a position change of components within the LiDAR system, or a position change of the LiDAR system itself relative to the body of the vehicle. When the galvanometer mirror's relative position within the LiDAR system's housing changes slightly, the zero position of the galvanometer mirror may be shifted. Other factors may also cause the shift, e.g., faults in the actuator or motor driving the movement of the galvanometer mirror, faults in the galvanometer mirror itself or any mechanical parts, or dust, dirt or moisture accumulated in the LiDAR system housing, etc. When galvanometer mirror's zero angle position is shifted, the corresponding LiDAR view of the external environment is also shifted.

FIG. 8B illustrates LiDAR view 801 of a road scene when the zero angle position of the galvanometer mirror in the LiDAR system has been shifted. In the illustration of FIG. 8B, the external environment is exactly the same as the external environment of FIG. 8A. No elements in the external environment in FIG. 8A has moved in FIG. 8B. In FIG. 8B, the zero angle position of the galvanometer mirror of the LiDAR system in has been shifted. This shift causes the 0° angle location of LiDAR view 801 to be shifted up by, e.g., 5 degrees. In other embodiments, a shift in zero angle position of the galvanometer mirror may cause the 0° angle location of LiDAR view 801 to be shifted down. Comparing FIG. 8B with FIG. 8A, LiDAR view 801 displays less of the road immediately ahead and more of the sky above the horizon than LiDAR view 800. while other objects (the road, the trees, and vehicle 802) stay the same. Conceptually, LiDAR view 801 can be visualized as a camera tilted upwards, or if the camera is fixed, the road (along with the horizon and the sky) is tilted downwards. Because of the shift, the data points representing vehicle 802 now correspond to 0° to 5° degrees in LiDAR view 801, instead of between 5° to 10° as in LiDAR view 800. As a result, because of the shift in zero angle position of the galvanometer mirror, the angle information of vehicle 802 is incorrectly obtained. This can cause error in the further processing of the LiDAR data.

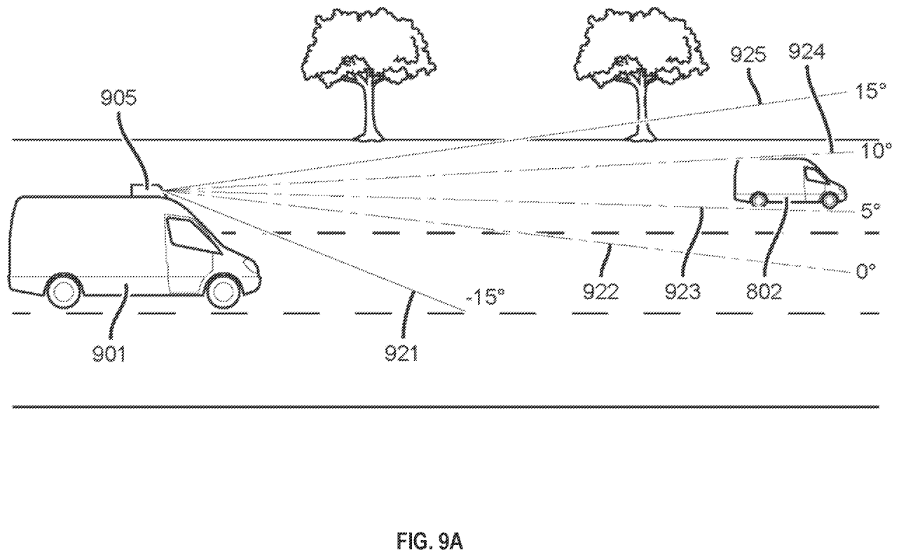

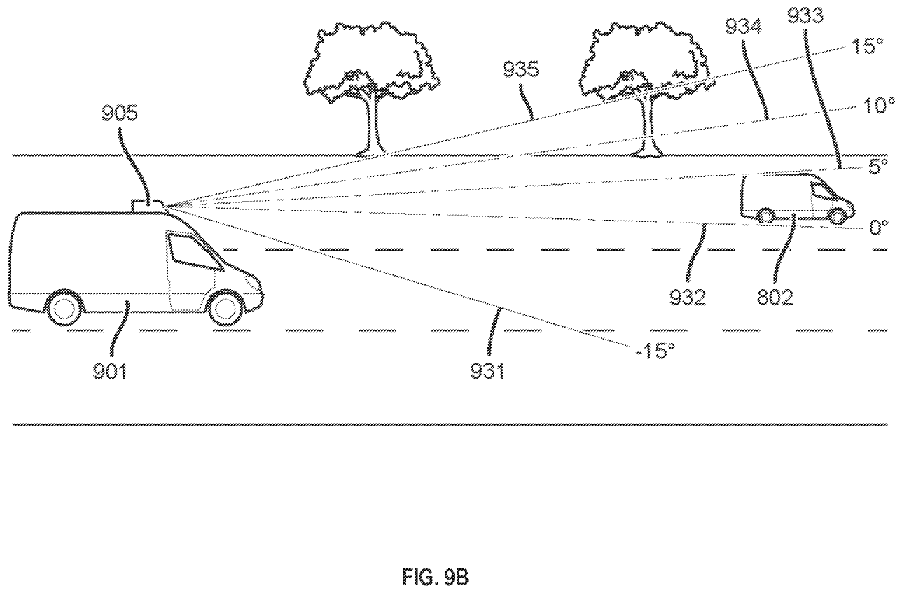

FIGS. 9A and 9B illustrate a lateral perspective of the same road scenes as in FIGS. 8A and 8B, respectively. FIG. 9A illustrates a road scene from a lateral perspective when the zero angle position of the galvanometer mirror in the LiDAR system is not shifted. LiDAR system 905 is mounted on top of vehicle 901. The vertical range of LiDAR system 905's FOV is from −15° to −15°. Line 921 represents the lower boundary of the vertical range (−15°). Line 925 represents the upper boundary of the vertical range (−15°). The 0° position of LiDAR system 905's FOV, which corresponds to the zero angle position of the galvanometer mirror, is represented by line 922. Same as in FIG. 8A, vehicle 802's vertical range is between 5° (line 923) to 10° (line 924) within the FOV.

FIG. 9B illustrates a road scene from a lateral perspective when the zero angle position of the galvanometer mirror in the LiDAR system has been shifted. Same as in FIG. 9A, LiDAR system 905 is mounted on top of vehicle 901. The external environment of FIG. 9B is exactly the same as the external environment of FIG. 9A. No elements in FIG. 9A has moved in FIG. 9B. In FIG. 9B, the zero angle position of the galvanometer mirror in LiDAR system 905 has been shifted. In FIG. 9B, the vertical range of LiDAR system 905's FOV is still from −15″ to −15° (between lines 931 and 935). However, the 0° position of LiDAR system 905's FOV (represented by line 932) has been shifted upwards (comparing to FIG. 9A). Therefore, in FIG. 9B, vehicle 802's vertical range is now between 0° (line 932) to 5° (line 933) within the FOV, instead of between 5° to 10° as in FIG. 9A. Again, because of the shift in zero angle position of the galvanometer mirror, the angle information of vehicle 802 is incorrectly obtained. Incorrect angular positions of objects in the FOV may affect the precision of positioning and/or distancing of the objects, which may in turn cause errors in further processing of the LiDAR point cloud data (e.g., wrong sensor fusion/perception/measuring/planning etc.).

A shift in zero angle position of the galvanometer mirror indicates a fault in the LiDAR system. The techniques discussed herein illustrate systems and methods for detecting the shift (or angle offset) in the zero position of the galvanometer mirror, providing a comprehensive solution for identifying and fixing faults in a LiDAR system. The techniques described herein may be performed in LiDAR system(s) 210, or vehicle perception and planning system 220, or both. Because the LiDAR system and the vehicle perception and planning system may use different coordinate systems, point cloud data generated by the LiDAR system may be converted to the vehicle's coordinate system for further processing.

Referring back to FIG. 2, in some embodiments, 3D point cloud data generated by LiDAR system(s) 210 can be provided to vehicle perception and planning system 220 via communication path 213 for further processing and controlling of the vehicle operations. Vehicle perception and planning system 220 may also use road detection sub-system 224 to localize the road and identify objects and/or markings on the road. For example, based on the raw data provided by other vehicle onboard sensor(s) 230, e.g., camera(s) 232, vehicle perception and planning system 220 can build a 3D model of the external environment. In some embodiments, the raw data from other vehicle onboard sensor(s) 230 may be fused with the LiDAR sensor data provided by LiDAR system(s) 210 to build the 3D model. Using the 3D model of the external environment, vehicle perception and planning system 220 can make decisions regarding operations of the vehicle, e.g., staying in a lane by driving within certain markings (lane lines) on the road, or reducing the speed when a speed bump ahead is identified, etc.

Both LiDAR system(s) 210 and the vehicle perception and planning system 220 may provide three-dimensional data representing the external environment. However, the two sets of data are generally based on two different 3D coordinate systems. In some embodiments, LiDAR system(s) 210 and other vehicle onboard sensor(s) 230, e.g., camera(s) 232, are mounted on, or integrated to, a vehicle at different locations on the vehicle. For example, a LiDAR system may be mounted on the rooftop, while a camera may be mounted on the front bumper. In other embodiments, LiDAR system 210 and camera 232 may be mounted at the same location on the vehicle. In that case, they may be arranged side-by-side, stacked on top of each other, or one inside the other, etc. However, even if they are mounted at the exact same location, LiDAR system 210 and camera 232 may be tilted at slightly different angles.

As a result of the above, the external environment as perceived by the two systems differs, leading to two different 3D coordinates generated by each system. To fuse the two sets of data together, one coordinate system may be converted to the other coordinate system. The coordinate system used by the LiDAR system(s) 210 is hereinafter referred to as the “LiDAR coordinate system”. The coordinate system used by vehicle perception and planning system 220 is hereinafter referred to as the “vehicle coordinate system.” In some embodiments, the LiDAR coordinate system is converted to the vehicle coordinate system for further processing, because the decisions regarding operations of the vehicle are made by vehicle perception and planning system 220. In other embodiments, the vehicle coordinate system is converted to the LiDAR coordinate system for further processing.

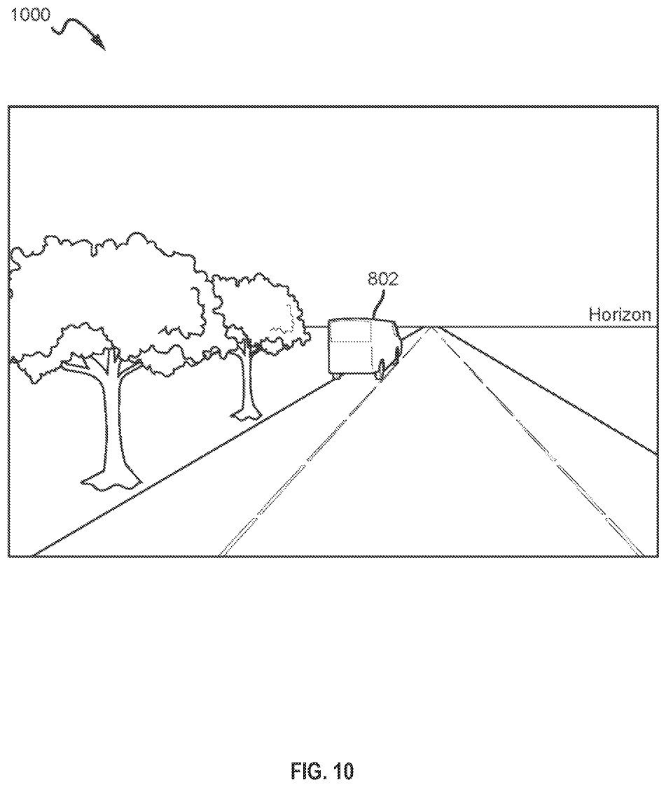

FIG. 10 illustrates a camera view 1000 of a road scene taken by camera 232 mounted on the vehicle's front bumper. For illustration purposes, the external environment of FIG. 10 is exactly the same as the external environment of FIGS. 8A, 8B, 9A and 9B. No elements in those figures have moved in FIG. 10. Camera 232 is mounted on the front bumper of the vehicle, while LiDAR system 905 is mounted on the rooftop. As a result, the camera's viewpoint is lower than that of the LiDAR system. When comparing FIG. 10 with FIG. 8A, it becomes apparent that camera 232's perspective (shown in camera view 1000) is lower than that of LiDAR system 905 (shown in LiDAR view 800). Due to the camera's lower vantage point in FIG. 10, both vehicle 802 and the trees appear taller than they do in FIG. 8A. As a result, the same object may have different coordinate values in the LiDAR coordinate system than it does in the vehicle coordinate system.

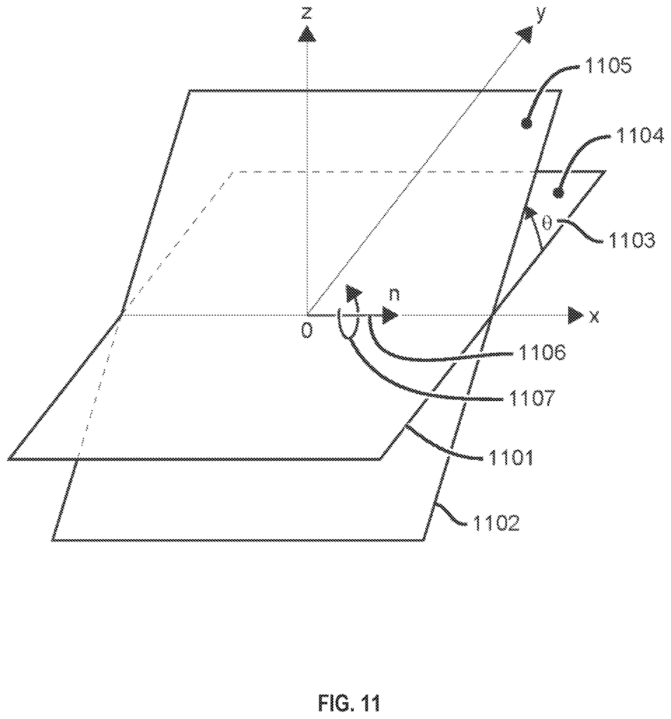

FIG. 11 depicts a 3D plot graph that shows a correlation between the LiDAR coordinate system and the vehicle coordinate system according to one embodiment. The x-y-z axes represent a 3D LiDAR coordinate system based on LiDAR's 3D point cloud data. In this coordinate system, the x-axis represents the horizontal direction of the LiDAR's 3D point cloud, the y-axis represents the depth of the LiDAR's 3D point cloud, and the z-axis represents the vertical direction of the LiDAR's 3D point cloud.

The origin of the LiDAR coordinate system can be based on the position of the LiDAR system housing within the external environment. Referring back to FIG. 9A, the origin of the LiDAR system 905's coordinate system can be the position of LiDAR system 905. Objects above line 922 (the 0° position of system 905's FOV) have positive z values, and objects below line 922 have negative z values. When selecting the origin of a coordinate system which represents a system's (LiDAR's or vehicle's) perception of its surroundings, the system's own location may be chosen as the origin. This may simplify calculations because the raw data collected by the system naturally start from its own location. In one embodiment, the origin of LiDAR system 905's coordinate system could be the location of system 905. In other embodiments, the origin of LiDAR system 905's coordinate system could be on the ground (or road) at the center of the car, on the car's front bumper, or at any other point within the three-dimensional space of FIG. 9A, except for the location of system 905. In these embodiments, the origin of the coordinate system can be calculated based on the raw 3D point cloud data generated. by LiDAR system 905.

There are several methods for converting a coordinate system from one to another. For example, if the two coordinate systems have the same orientation but different origins, a translation vector can be added to each point in the first coordinate system to obtain the corresponding point in the second coordinate system. If the two coordinate systems have the same origin but different orientations, a rotation matrix can be applied to each point in the first coordinate system to obtain the corresponding point in the second coordinate system. If the two coordinate systems have both different orientation and origins, a homogeneous transformation matrix, which combines the translation vector and the rotation matrix, can be applied to each point in the first coordinate system to obtain the corresponding point in the second coordinate system.

The origin of the vehicle coordinate system may be the same or different from that of the LiDAR coordinate system. For example, if the origin of the two coordinate systems is simply the location of each system, the origins may be the same if camera 232 is mounted at the same position as LiDAR system 905. The origins may be different if the two devices are mounted at different positions. If the origins of one or both systems are calculated, e.g., both calculated to be at the same position on the ground, then the two origins could also be the same. The techniques described herein assume that the LiDAR coordinate system and the vehicle coordinate system have the same origin. A person of ordinary skill in the art would understand how to use other methods (including those described above) to convert the coordinate system when the origins of the two coordinate systems may differ.

As previously mentioned, objects appear higher in the vehicle coordinate system of FIG. 10 as compared to the LiDAR coordinate system of FIG. 8A. This means that in one embodiment, the vehicle coordinate system can be converted from the LiDAR coordinate system by rotating the LiDAR coordinate system at a rotation angle along a rotation axis. With reference still to FIG. 11, points 1104 and 1105, and planes 1101 and 1103 are used as examples herein to illustrate the correlation between the two coordinate systems. Point 1104 lies on plane 1101 and point 1105 lies on plane 1102, Plane 1101 represents a horizontal plane with equation z=0, intersecting the x and y axes at the origin of the LiDAR coordinate system. After rotation, point 1104 in the LiDAR coordinate system transforms to point 1105 in the vehicle coordinate system. Similarly, plane 1101 in the LiDAR coordinate system transforms to plane 1102 in the vehicle coordinate system. To convert from the LiDAR coordinate system to the vehicle coordinate system, every point in the LiDAR coordinate system is rotated at an angle θ (1103) around a rotation axis along direction 1107. To simplify the illustration in FIG. 11, the rotation axis is the same as the x-axis, Rotation vector (also referred to as “reference rotation vector”) is depicted as vector n (1106) along the rotation axis. In other embodiments, the rotation axis can be any line in the coordinate system, and the rotation vector can point to any direction.

The rotation vector and the rotation angle are two of the conversion parameters that are used to convert from LiDAR coordinate system to the vehicle coordinate system. Conversion parameters may also include other parameters, e.g., a translation vector, a transformation matrix, etc. Conversion parameters are generated and provided by vehicle perception and planning system 220. In some embodiments, conversion parameters are generated when the LiDAR system is first mounted, based on the differences (e.g., angular and/or spatial offsets) between the LiDAR system coordinate and the vehicle system coordinate. Conversion parameters may also be generated at every startup of the vehicle and may be periodically updated. In some embodiments, they are generated by comparing the sensor data provided by the LiDAR system(s) 210 and other vehicle onboard sensor(s) 230, and/or the vehicle's IMU, GPS, the LiDAR system's IMU, etc.

When conversion parameters such as a rotation vector n and a rotation angle θ are obtained from the vehicle, LiDAR coordinate system can be converted to the vehicle coordinate system using a rotation matrix R. In some embodiments, rotation matrix R can be calculated using the following Rodrigues' formula (formula (1)):

R=cos θI+(1−cos θ)nn^{T}+sin θn\hat{ } (1)

where I is the identity matrix, n is the unit vector of the rotation axis, θ is the rotation angle, nn^{T} is the outer product of n with itself, and \hat{ }is the operator for transforming a vector to the anti-symmetric matrix.

101251 After rotation matrix R is calculated, any vector in the LiDAR coordinate system can be rotated to become a new vector in the vehicle coordinate system by using the following formula (2):

N′=R·N (2)

where N is a vector in the LiDAR coordinate system, R is the rotation matrix, and N′ is the new, rotated vector in the vehicle coordinate system.

In some embodiments, after a point, line, vector, or plane from the LiDAR's 3D point cloud data has been transformed from the LiDAR coordinate system to the vehicle coordinate system using the rotation matrix R, a shift in the zero position of the galvanometer meter in the LiDAR system may be detected. This can be achieved by comparing the LiDAR's road surface plane derived from LiDAR's point cloud data with the native horizontal plane of the vehicle coordinate system.

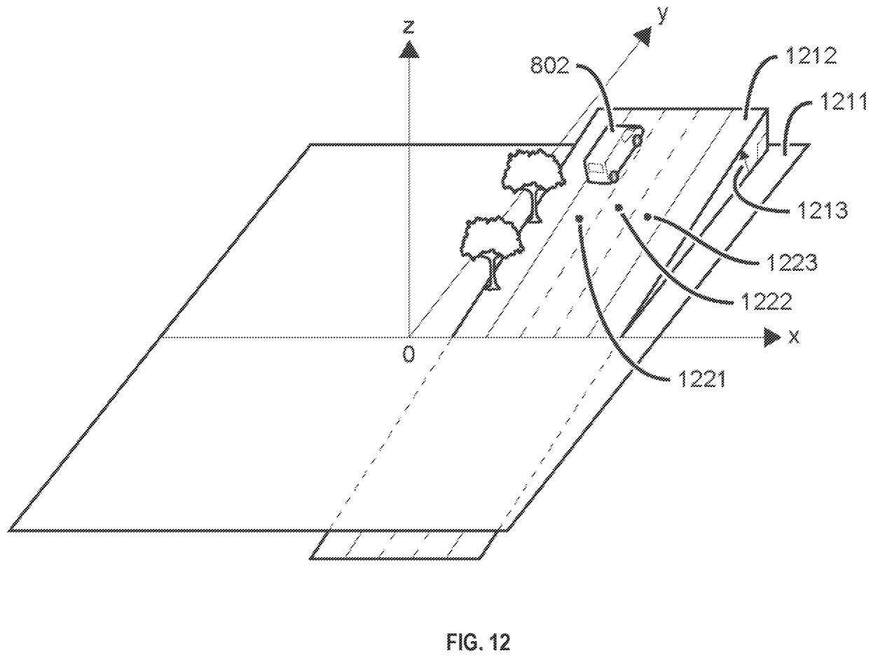

FIG. 12 depicts a 3D plot graph that shows a correlation between the road surface plane and the vehicle's native horizontal plane according to one embodiment. The x-y-z axes represent a vehicle coordinate system. The x-axis represents the horizontal direction of the vehicle coordinate system, the y-axis represents the depth of the vehicle coordinate system, and the z-axis represents the vertical direction of the vehicle coordinate system. Plane 1211 is the vehicle's native horizontal plane (described in more detail below). Plane 1212 is the road surface plane derived from the LiDAR's point cloud data (after the plane is converted from the LiDAR coordinate system to the vehicle coordinate system). The positions of vehicle 802, the trees, and the lanes, etc. in plane 1212 are identical to their positions in FIGS. 8A, 9A, and 10. No elements in those figures have moved in plane 1212. Plane 1212 is a 3D visualization of the same road scene depicted in those figures viewed from a different perspective. Vehicle 901, where LiDAR system 905 is mounted, is not shown in FIG. 12 in order to simply the illustration.

In some embodiments, road surface plane 1212 can be obtained by first fitting a plane equation of the road surface based on selected reference points on the road, and then by converting the fitted plane from the LiDAR coordinate system to the vehicle coordinate system. To fit the equation of the road surface plane, first, a set of reference points on the road surface is selected from the LiDAR point cloud data. Selection of these points may affect the accuracy of the plane equation. The reference points are selected with a focus on the points located in front of the car and within a certain distance on either side. For example, reference points can be selected within a selection range of about 15 meters in front of vehicle 901 (not shown in the figure), e.g., point 1222, and within about 0.8 meters on each side, e.g., points 1221 and 1223. However, different selection range can be used to select the reference points. For example, reference points may be chosen within a selection range of about 20 meters or more in front of the car, or up to about 1.5 meters or more on each side of the car, etc. In addition, three reference points are shown in FIG. 12 for illustration purpose only. Any number of reference points can be selected, such as 100, 500, or 2,000 or more reference points may be selected. To a certain extent, increasing the number of reference points may improve the accuracy of the plane equation calculation.

In some embodiments, after the reference points have been selected, they may be compared to a threshold value to determine if they meet the threshold requirement. This threshold value can take any numerical value, such as 50, 100, 500, or 4,000, etc. If the total number of reference points exceeds the threshold value, it is determined that the conditions for plane fitting have been met, and plane-fitting methods described herein may be performed.

In some embodiments, after the reference points are selected, they can be used to tit the road surface plane equation. There are several ways to fit a plane equation from 3D data points. For example, plan equation may be fitted using Principal Component Analysis (PCA), Maximum Likelihood Estimation Method, or Geometric Method, etc. One approach to fitting the plane equation described herein involves the RANSAC (RANdom SAmple Consensus) algorithm and the least squares method. A person of ordinary skill in the art would understand how to use other methods to fit road surface plane equation.

The reference points selected to fit the road surface plane (such as points 1221-1223 and other points not shown in the figure) may include data that is not actually on the road surface. This may happen when, e.g., objects like flying debris or plastic, bags on the road are mistakenly selected as reference points, because they happen to fall within the selection range. This may also happen when the road is uneven, e.g., there are obstacles, bumps, curves, or potholes, etc., on the road. As a result, the set of selected reference points may contain noisy data. In some embodiments, the RANSAC algorithm is used to estimate model parameters from a dataset that contains abnormal (noisy) data. Taking in all the selected reference points on the road surface as input sample data, the algorithm selects a subset of data points (the inlier set) that are likely to belong to an underlying model. Then, the algorithm estimates the model parameters based on the inlier set. The remaining data points that may contain abnormal data are then compared to the fitted model, and are added to the inlier set if they are consistent with the model. Data points in the inlier set are not outliers or noise. This process is repeated a number of times, and the model with the largest inlier set is selected as the best estimate of the underlying model.

After the set of best-estimated data is obtained by the RANSAC algorithm, in some embodiments, a least squares method is used to find the best-fit plane that approximates the set of best-estimated data points. The least squares method is a regression technique. It finds the best plane function that fits the data points by minimizing the sum of the squared distances between the data points and the plane.

Using the plane-fitting methods described above, the road surface plane that can best-fit the selected reference points on the road can be derived. The derived plane can be represented by the following formula (3):

Ax+By+Cz+D=0 (3)

where x, y, and z are the three axes of the LiDAR coordinate system, A, B and C are the components of the normal vector to the plane, and D is the distance from the road surface plane to the origin. The normal vector to the road surface plane can be expressed as: Nᵣ=(A, B, C).

In some embodiments, after the road surface plane is fitted based on the selected reference points, a variance of the fitted plane is calculated. Variance of a fitted plane is a measure of how well the plane fits the data points. A lower variance indicates a better fit, while a higher variance indicates a poorer fit. The variance of the fitted road surface plane can be calculated by traversing all the sampled points on the road surface (the dataset) and using following formula (4):

$${s}^{2} = \frac{\sum {( x - \overline{x} )}^{2}}{n} \qquad ( 4 )$$

where s is the variance of the fitted plane, x is the value of each individual sample in the dataset, \tilde{x} is the mean of all the samples in the dataset, and n is the total number of samples in the dataset.

In some embodiments, after the variance of the fitted road surface plane is calculated, it is compared with a variance threshold to determine if the quality of the fitted plane is acceptable. If the variance does not exceed the variance threshold, it means that the fitted road surface plane is acceptable for further processing. If the variance is greater than the variance threshold, it means that the quality of plane-fitting is poor and fitted plane may not be used for processing.

The vehicle's native horizontal plane 1211 is provided by vehicle perception and planning system 220 in the vehicle coordinate system. It represents the plane on which the vehicle is positioned. For example, if the vehicle is placed on a flat, level road, then the native horizontal plane coincides with the surface of the road. A vehicle's native horizontal plane may shift over time. This can occur due to various factors such as changes in the vehicle's suspension or tires, causing the vehicle to tilt slightly. In some embodiments, the native horizontal plane is contained in the map data of the vehicle's external environment provided by the vehicle in the vehicle coordinate system.

In the vehicle coordinate system, the native horizontal plane can be expressed by equation z=d, where d is the z-intercept of the native horizontal plane. The value of d depends on the position of the vehicle coordinate system, which could be on the car's front bumper, or on the ground at the center of the car, etc. Consequently, d can be positive, negative, or zero, depending on the relative position of the camera to the native horizontal plane. The normal vector to the vehicle's native horizontal plane can be expressed as: Nᵥ=(0, 0, 1).

Ideally, the road surface plane derived from the selected LiDAR point cloud data (after being converted to the vehicle coordinate system) should match the vehicle's native horizontal plane. This is because they both reference the same physical plane. If after converting the road surface plane from the LiDAR coordinate system to the vehicle coordinate system, a deviation angle between the two planes exists and exceeds a threshold, then it may indicate that a fault in the LiDAR system has occurred.

There are several methods to compare two planes in a 3D coordinate system to determine any angular differences between them. One method involves using a matrix to find a rotation matrix that transforms one plane into the other, and then extracting the rotation angle from the matrix. The rotation angle may also be found using the cross product of the normal vectors of the two planes, or by taking the inverse cosine of the dot product of the two normal vectors. The dot product method is described herein. A person of ordinary skill in the art would understand how to use other methods to find the angular difference between the two planes.

Before comparing the LiDAR's road surface plane with the vehicle's native horizontal plane, the road surface plane needs to be converted from the LiDAR coordinate system to the vehicle coordinate system. Given the normal vector to the road surface plane obtained previously expressed as Nᵣ=(A, B, C), and the rotation matrix R obtained from formula (1), the rotated, new normal vector Nᵣ′ of the new road surface plane 1212 in the vehicle coordinate system can be obtained by applying formula (2) to Nᵣ, as in: Nᵣ′=R·Nᵣ.

In some embodiments, after the aforementioned conversion, the deviation angle (angle 1213) between the new, converted road surface plane 1212 and the vehicle's native horizontal plane 1211 can be calculated using the dot product method. The deviation angle between the two planes can be determined by calculating the dot product between their normal vectors (not shown in the figure). The dot product of two vectors is the product of their magnitudes and the cosine of the angle between them. Then, the deviation δ (angle 1213) between the two planes can be found by taking the inverse cosine of the dot product of their normal vectors, as shown in formula (5) below:

$$δ = {cos}^{- 1} \frac{{N}_{r}^{′} \cdot {N}_{ν}}{\vert {N}_{r}^{′} \vert \vert {N}_{v} \vert} \qquad ( 5 )$$

where δ0 is the deviation angle between the road surface plane and the vehicle's native horizontal plane, Nᵣ′ is the normal vector of the road surface plane, Nᵥ is the vehicle's native horizontal plane obtained previously, · denotes a dot product operation between the two vectors, and ∥ denotes magnitude of the normal vector.

After the deviation angle is obtained, it is compared with a deviation angle threshold to determine whether the deviation angle exceeds the deviation angle threshold. If the deviation angle exceeds the threshold, then it may indicate that an abnormal shift in the galvanometer meter's zero position, which further indicates that a fault in the LiDAR system has occurred. In some embodiments, the fault in the LiDAR system is reported to the vehicle for further handling of the fault. For example, a user notification may be generated to alert the user that the LiDAR system may need recalibration. In some embodiments, a system notification may be generated to alert the vehicle system so that vehicle perception and planning system 220 may take the fault into account when processing data from the external environment. In some embodiments, vehicle perception and planning system 220 may modify the received LiDAR data using image processing techniques, e.g., applying an offset, in order to compensate the shift in the LiDAR data caused by the fault. In some embodiments, a fault code may he set or cleared depending on whether the fault is found or not found.

In some embodiments, the determination that a fault has occurred may not be based on just a single instance in which the deviation angle exceeds the deviation angle threshold. Instead, a count is kept of each detection result (whether the deviation angle exceeds the threshold or not), and the percentage of deviations that exceed the threshold is calculated as a proportion of the total number of detections. If this percentage exceeds a certain threshold, it is considered highly likely that a fault has occurred in the zero position of the galvanometer mirror.

In some embodiments, an array may be used to keep track of the results of the calculation, determination or detection discussed in various steps in this disclosure. The array may be a sliding array with a fixed length, such as 10, 25, or 40, etc. The detection results may be updated in the array for every frame, either at the end of each frame or immediately after each calculation, determination or detection. The detection results to be updated in the array may include, but not limited to, the following: whether the deviation angle exceeds the deviation angle threshold, whether the total number of selected reference points exceeds a threshold, whether the variance exceeds the variance threshold, and whether the vehicle speed exceeds a vehicle speed threshold, etc.

In sonmr embodiments, the road surface plane may be better fitted when the vehicle is traveling at a high speed, e.g., at 80 km/h. This is because when travelling at higher speeds, the vehicle is likely driving on a flat roadway, e.g., a highway or expressway, hence the road surface is less likely to have obstacles, bumps, curves, or potholes. As explained previously, these obstacles may introduce noise into the sampled data, thus may affect the quality of the plane-fitting methods described above and the resulting fitted plane. Therefore, in some embodiments, detection of galvanometer meter's zero position in the LiDAR system may be better performed when the vehicle is traveling at a high speed. However, in other embodiments, the detection can still be performed when the vehicle is traveling at lower speeds or is stationary. In these embodiments, the detection can be better performed when the road or ground in front of the car is flat and/or even.

Referring back to FIG. 2, the speed of the vehicle may be obtained from other vehicle onboard sensor(s) 230, vehicle perception and planning system 220, vehicle control system 280 vehicle interface 270, or any other components in the figure. After the vehicle speed is obtained, it is compared with a vehicle speed threshold to determine whether the vehicle speed exceeds the vehicle speed threshold. The vehicle speed threshold can be any speed the vehicle is capable of. For example; the vehicle speed threshold may be about 0 km/h, about 25 km/h, about 60 km/h, about 80 km/h, or about 120 km/h, etc.

In some embodiments, the derived road surface plane in the LiDAR coordinate system is not converted and compared with the vehicle's native horizontal plane. Instead, the derived road surface plane expressed in the LiDAR coordinate system, e.g., its normal vector Nᵣ=(A, B, C), is saved as historical data for future analysis. As the zero position of the galvanometer mirror may shift over time, the road surface plane derived currently may be compared with the saved historical data to determine if the zero position has been shifted from before. In this way, the detection of galvanometer mirror's fault can be performed by vehicle onboard LiDAR system(s) 220 itself, without the need for communicating with vehicle perception and planning system 220.

Referring back to FIG. 7, in some embodiments, steering mechanism 700 may not include a galvanometer mirror. Instead, steeling mechanism 700 may include a variable angle multi-facet polygon (VAMFP). VAMFP is described in more detail in U.S. non-provisional patent application Ser. No. 16/837,429, filed on Apr. 1, 2020. entitled “Variable Angle Polygon For Use With A Lidar System”, the content of which is incorporated by reference in it is entirety for all purposes. A VAMFP is a polygon mirror with multiple facets, where each facet has a variable angle relative to the adjacent facets. A VAMFP rotates along its center axis. A rotating VAMFP may scan the outgoing light in both horizontal and vertical directions. The horizontal scanning is achieved by rotating each facet of the VAMFP in a horizontal direction. As the VAMFP rotates, the variable angles of each facet allow for scanning in the vertical direction. Sometimes, due to shocks or vibrations of the vehicle or other factors similar to those previously described, the position of VAMFP may change over time. For example, the rotational axis of the VAMFP may be slightly titled. As a result, the vertical center of the LiDAR view may be shifted, resulting in a fault in the LiDAR system similar to the fault of the galvanometer mirror described herein. Therefore, the methods and algorithms described in this disclosure can also be used to detect faults in a LiDAR system that employs VAMFP.

FIG. 13 is a flowchart illustrating a method for detecting fault in a LiDAR system mounted on a vehicle. In some embodiments, method 1300 may be performed by vehicle onboard LiDAR system(s) 210 in FIG. 2, vehicle perception and planning system 220 in FIG. 2, vehicle control system 280 in FIG. 2, LiDAR system 300 in FIG. 3, and/or by a combination of two or more of the preceding systems. Any of the preceding systems or a combination thereof are hereinafter referred to as the “fault-detection system.” The steps described below are performed by the fault-detection system using the various methods and algorithms described above. It should be understood that the order of steps described below is not limited to the specific order disclosed, and that one or more steps may be omitted or repeated as long as the invention remains operable.

Method 1300 includes step 1310, in which the fault-detection system obtains a vehicle speed. Referring back to FIG. 2, vehicle speed may be obtained from other vehicle onboard sensor(s) 230, vehicle perception and planning system 220, vehicle control system 280 vehicle interface 270, or any other components in the figure.

Method 1300 further includes step 1320, in which the fault-detection system obtains conversion parameters used for converting from a LiDAR coordinate system to a vehicle coordinate system. LiDAR coordinate system is a coordinate system used by the LiDAR system(s) 210. Vehicle coordinate system is a coordinate system used by vehicle perception and planning system 220. Conversion parameters may be used for converting a point, line, vector, or plane from a LiDAR coordinate system to a vehicle coordinate system. Conversion parameters include rotation vector and the rotation angle, and may include other parameters, e.g., a translation vector, a transformation matrix, etc. Conversion parameters are generated and provided by vehicle perception and planning system 220. In some embodiments, conversion parameters are generated when the LiDAR system is first mounted. Conversion parameters may also be generated at every startup of the vehicle and may be periodically updated.

In some embodiments, step 1320 may include the following further steps, in which the fault-detection system obtains the reference rotation vector and the rotation angle from the vehicle, and converts the reference rotation vector to a rotation matrix. In some embodiments, rotation matrix can be calculated from the reference rotation vector and the rotation angle using formula (1).

Method 1300 further includes step 1330, in which the fault-detection system determines whether the vehicle speed exceeds a vehicle speed threshold. After the vehicle speed is obtained, it is compared with a vehicle speed threshold to determine whether the vehicle speed exceeds the vehicle speed threshold. The vehicle speed threshold can be any speed the vehicle is capable of example, the vehicle speed threshold may be about 0 km/h, about 25 km/h, about 60 km/h, about 80 km/h, or about 120 km/h, etc.

Method 1300 further includes step 1340, in which the fault-detection system, in accordance with a determination that the vehicle speed exceeds the vehicle speed threshold, obtains a representation of a road surface plane expressed in the vehicle coordinate system. Road surface plane can be derived from the LiDAR's point cloud data of the road surface in front of the vehicle. A representation of the road surface plane can be expressed by formula (3), or by a normal vector to the road surface plane expressed as: Nᵣ=(A, B, C), where A, B and C are the components of the normal vector to the road surface plane expressed by formula (3).

In some embodiments, step 1340 may include the following further steps, in which the fault-detection system obtains the point cloud data provided by the LiDAR system, derives the road surface plane based on the point cloud data, obtains the representation of the road surface plane, and converts the representation of the road surface plane from the LiDAR coordinate system to the vehicle coordinate system using the conversion parameters. The road surface plane can be derived by fitting a plane equation of the road surface based on selected reference points on the road. In some embodiments, this can be achieved by selecting a plurality of reference points on a road surface from the point cloud data, and deriving the road surface plane based on the selected plurality of reference points. The reference points are selected with a focus on the points located in front of the car and within a certain distance on either side. In some embodiments, the road surface plane may be derived using the RANSAC algorithm and the least squares method. The representation of the derived road surface plane can be expressed as Nᵣ=(A, B, C) as described above. The representation of the new road surface plane converted from the LiDAR coordinate system to the vehicle coordinate system, expressed as Nᵣ′, can be obtained by applying formula (2) to Nᵣ, as in: Nᵣ′=R·Nᵣ.

In some embodiments, step 1340 may also include the following further step, in which the fault-detection system determines whether a total number of the plurality of reference points satisfies a condition for deriving the road surface plane. The determination can be made based on whether the total number of reference points exceeds a threshold value. If the total number of reference points exceeds the threshold value, it can be determined that the conditions for plane fitting have been met.

In some embodiments, step 1340 may include further steps, in which the fault-detection system calculates a variance between the derived road surface plane and the road surface, and determines whether the variance exceeds a variance threshold. Variance of a fitted plane is a measure of how well the plane fits the data points, which can be calculated using formula (4). After the variance of the fitted road surface plane is calculated, it is compared with a variance threshold to determine if the quality of the fitted plane is acceptable. If the variance does not exceed the variance threshold, it means that the fitted road surface plane is acceptable for further processing.

Method 1300 further includes step 1350, in which the fault-detection system obtains a representation of a native horizontal plane provided by the vehicle. A vehicle's native horizontal plane is provided by vehicle perception and planning system 220 in the vehicle coordinate system. It represents the plane on which the vehicle is positioned. A representation of the native horizontal plane can be expressed by equation z=d in the vehicle coordinate system, where d is the z-intercept of the native horizontal plane. A representation of the native horizontal plane may also be the normal vector to the vehicle's native horizontal plane, which can be expressed as: Nᵥ=(0, 0, 1).

Method 1300 further includes step 1360, in which the fault-detection system determines whether a fault in the LiDAR system has occurred based on the representation of the road surface plane and the representation of the native horizontal plane. The determination can be based on whether a deviation angle between the road surface plane and the native horizontal plane exists and exceeds a threshold. In some embodiments, the determination may not be based on just a single instance in which the deviation angle exceeds the deviation angle threshold. Instead, a count is kept of each detection result (whether the deviation angle exceeds the threshold or not), and the percentage of deviations that exceed the threshold is calculated as a proportion of the total number of detections. If this percentage exceeds a certain threshold, it is considered highly likely that a fault has occurred in the zero position of the galvanometer mirror.

In some embodiments, the determination may not be based on just a single instance in which the deviation angle exceeds the deviation angle threshold. Instead, a count is kept of each detection result (whether the deviation angle exceeds the threshold or not), and the percentage of deviations that exceed the threshold is calculated as a proportion of the total number of detections. If this percentage exceeds a certain threshold, it is considered highly likely that a fault has occurred in the zero position of the galvanometer mirror.

In some embodiments, method 1300 may further include the following step, in which the fault-detection system, based on the determination that the fault in the LiDAR system has occurred, sends information of the fault to the vehicle. For example, a user notification may be generated to alert the user that the LiDAR system may need recalibration. In some embodiments, a system notification may be generated to alert the vehicle system so that vehicle perception and planning system 220 may take the fault into account when processing data from the external environment. In some embodiments, vehicle perception and planning system 220 may modify the received LiDAR data using image processing techniques, e.g., applying an offset, in order to compensate the shift in the LiDAR data caused by the fault. In some embodiments, a fault code may be set or cleared depending on whether the fault is found or not found.

The foregoing specification is to be understood as being in every respect illustrative and exemplary, but not restrictive, and the scope of the invention disclosed herein is not to be determined from the specification, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

What is claimed is:

1. A fault-detection system for detecting fault in a light detection and ranging (LiDAR) system mounted on a vehicle, the LiDAR system being configured to provide point cloud data of an external environment of the vehicle in accordance with a LiDAR coordinate system, the fault-detection system comprising:
one or more processors,
a memory device, and
processor-executable instructions stored in the memory device, the processor-executable instructions comprising instructions for:
obtaining a vehicle speed;
obtaining conversion parameters used for converting from the LiDAR coordinate system to a vehicle coordinate system;
determining whether the vehicle speed exceeds a vehicle speed threshold;
in accordance with a determination that the vehicle speed exceeds the vehicle speed threshold, obtaining a representation of a road surface plane expressed in the vehicle coordinate system;
obtaining a representation of a native horizontal plane provided by the vehicle; and
determining whether a fault in the LiDAR system has occurred based on the representation of the road surface plane and the representation of the native horizontal plane.

2. The fault-detection system of claim 1, wherein the vehicle is configured to provide map data of the external environment of the vehicle in accordance with the vehicle coordinate system, the map data comprising the representation of the native horizontal plane of the external environment.

3. The fault-detection system of claim 1, wherein obtaining the conversion parameters used for converting from the LiDAR coordinate system to the vehicle coordinate system comprises:
obtaining a reference rotation vector and a rotation angle from the vehicle; and
converting the reference rotation vector to a rotation matrix.

4. The fault-detection system of claim 1, wherein obtaining the representation of the road surface plane expressed in the vehicle coordinate system comprises:
obtaining the point cloud data provided by the LiDAR system;
deriving the road surface plane based on the point cloud data;
obtaining the representation of the road surface plane; and
converting the representation of the road surface plane from the LiDAR coordinate system to the vehicle coordinate system using the conversion parameters.

5. The fault-detection system of claim 4, wherein deriving the road surface plane from the point cloud data comprises:
selecting a plurality of reference points on a road surface from the point cloud data; and
deriving the road surface plane based on the plurality of reference points on the road surface.

6. The fault-detection system of claim 5, wherein the processor-executable instructions comprise further instructions for:
determining whether a total number of the plurality of reference points satisfies a condition for deriving the road surface plane.

7. The fault-detection system of claim 5, wherein the processor-executable instructions comprise further instructions for:
calculating a variance between the derived road surface plane and the road surface; and
determining whether the variance exceeds a variance threshold.

8. The fault-detection system of claim 1, wherein determining whether the fault in the LiDAR system has occurred comprises:
calculating a deviation angle between the representation of the road surface plane and the representation of the native horizontal plane; and
determining whether the deviation angle exceeds a deviation angle threshold.

9. The fault-detection system of claim 1, wherein the processor-executable instructions comprise further instructions for:
based on the determination that the fault in the LiDAR system has occurred, sending information of the fault to the vehicle.

10. A method for detecting fault in a light detection and ranging (LiDAR) system mounted on a vehicle, the method comprising:
obtaining a vehicle speed;
obtaining conversion parameters used for converting from a LiDAR coordinate system to a vehicle coordinate system;
determining whether the vehicle speed exceeds a vehicle speed threshold,
in accordance with a determination that the vehicle speed exceeds the vehicle speed threshold, obtaining a representation of a road surface plane expressed in the vehicle coordinate system;
obtaining a representation of a native horizontal plane provided by the vehicle; and
determining whether a fault in the LiDAR system has occurred based on the representation of the road surface plane and the representation of the native horizontal plane.

11. The method of claim 10, wherein the vehicle is configured to provide map data of the external environment of the vehicle in accordance with the vehicle coordinate system, the map data comprising the representation of the native horizontal plane of the external environment.

12. The method of claim 10, wherein obtaining the conversion parameters used for converting from the LiDAR coordinate system to the vehicle coordinate system comprises:
obtaining a reference rotation vector and a rotation angle from the vehicle; and
converting the reference rotation vector to a rotation matrix.

13. The method of claim 10, wherein obtaining the representation of the road surface plane expressed in the vehicle coordinate system comprises:
obtaining the point cloud data provided by the LiDAR system;
deriving the road surface plane based on the point cloud data;
obtaining the representation of the road surface plane; and
converting the representation of the road surface plane from the LiDAR coordinate system to the vehicle coordinate system using the conversion parameters.

14. The method of claim 13, wherein deriving the road surface plane from the point cloud data comprises:
selecting a plurality of reference points on a road surface from the point cloud data; and
deriving the road surface plane based on the plurality of reference points on the road surface.

15. The method of claim 14, wherein the processor-executable instructions comprise further instructions for:
determining whether a total number of the plurality of reference points satisfies a condition for deriving the road surface plane.

16. The method of claim 14, wherein the processor-executable instructions comprise further instructions for:
calculating a variance between the derived road surface plane and the road surface; and
determining whether the variance exceeds a variance threshold.

17. The method of claim 10, wherein determining whether the fault in the LiDAR system has occurred comprises:
calculating a deviation angle between the representation of the road surface plane and the representation of the native horizontal plane; and
determining whether the deviation angle exceeds a deviation angle threshold.

18. The method of claim 10, wherein the processor-executable instructions comprise further instructions for:
based on the determination that the fault in the LiDAR system has occurred, sending information of the fault to the vehicle.
